(19) United States
(12) Patent Application Publication
(10) Pub. No.: US 2022/0024824 A1
(43) Pub. Date: Jan. 27, 2022

(54) Ceramic Surface Modification Materials and Methods of Use Thereof

(71) Applicant: Nelumbo Inc., Hayward, CA (US)

(72) Inventors: Lance R. BROCKWAY, Hayward, CA (US); David C. WALTHER, Hayward, CA (US); Nicholas J. MONTES, Hayward, CA (US)

(21) Appl. No.: 17/312,319

(22) PCT Filed: Dec. 12, 2019
(86) PCT No.: PCT/US19/65978

§ 371 Date: Jun. 9, 2021

Related U.S. Application Data
(60) Provisional application No. 62/778,888, filed on Dec. 12, 2018.

(51) Int. Cl. C04B 38/00; C04B 35/03; C04B 35/10; C04B 35/45; C04B 35/453; C04B 35/50; C23C 18/12

(52) U.S. Cl. CPC C04B 38/0054; C04B 38/0064; C04B 35/03; C04B 35/10; C04B 2111/40; C04B 35/453; C04B 35/50; C23C 18/1283; C23C 18/1295; C04B 35/45

(57) ABSTRACT

Porous, binderless ceramic surface modification materials are described, and applications of use thereof. The ceramic material may include a metal oxide and/or metal hydroxide, and/or hydrates thereof, on a substrate surface.

### CROSS-REFERENCE TO RELATED APPLICATIONS

This application claims the benefit of U.S. Provisional Application No. 62/778,888, filed on Dec. 12, 2018, which is hereby incorporated by reference herein in its entirety.

### FIELD OF THE INVENTION

The invention relates to ceramic surface modification materials, in particular, binderless porous ceramics, such as metal oxide and/or metal hydroxide ceramics on a substrate surface.

### BACKGROUND

Coatings and surface modifications are used to improve articles of commerce and to provide additional benefit. One such area of application is to provide additional electrochemical or corrosion protection of the articles. Other desirable properties include visual appearance, or wettability, or electrical properties. To provide a useful benefit, these coatings and surface modifications should be durable to the environmental service conditions. Other desirable attributes of surface modifications and coatings include surfaces that are thin, conformal, have a wide operating range of conditions, and are unobtrusive to the article. Surface modifications and coatings which are multifunctional are further desired.

### BRIEF SUMMARY OF THE INVENTION

Binderless porous ceramic compositions comprising metal oxides, metal hydroxides, hydrates of metal oxides, and/or hydrates of metal hydroxides, or combinations thereof, and methods of making and applications of use of such compositions are provided.

In one aspect, a binderless (e.g., surface immobilized) porous ceramic surface modification material on a substrate is provided. In some embodiments, the ceramic material includes a metal oxide, a metal hydroxide, a hydrate of a metal oxide, and/or a hydrate of a metal hydroxide. In some embodiments, the ceramic material includes a metal hydroxide, and at least a portion (e.g., at least about 5%, 10%, 15%, 20%, 25%, 30%, 35%, 40%, 45%, 50%, 55%, 60%, 65%, 70%, 75%, 80%, 85%, 90%, or 95%) is in the form of layered double hydroxide. In some embodiments, the binderless porous ceramic surface modification material is a mixed metal oxide and/or hydroxide, and/or hydrates thereof, ceramic material. In some embodiments, the surface modification material is immobilized on the substrate.

In some embodiments, the substrate includes a metal and the primary metal in the ceramic material is different than the primary metal in the substrate. For example, a metal that is greater than 50%, 60%, 70%, or 80% of the total metal in the ceramic material is different than a metal that is greater than 50%, 60%, 70%, or 80% of the total metal in the substrate.

In some embodiments, the binderless porous ceramic material is primarily crystalline (e.g., exhibiting ordered and controlled growth) versus amorphous or glassy (e.g., exhibiting freezing of a bulk composition). A crystalline composition is a regularly ordered array of components held together by intermolecular forces. Crystallinity may be determined, for example, by the presence of peaks due to constructive interference in x-ray diffraction. Primarily crystalline binderless porous ceramic material may be, for example, at least about 50%, 55%, 60%, 65%, 70%, 75%, 80%, 85%, 90%, or 95% crystalline.

In some embodiments, binderless porous ceramic surface modification materials as described herein include an open cell porous structure. For example, the open cell porous structure may be characterized by: capillary rise of a solvent having a surface tension less than about 25 mN/m of greater than about 5 mm up a vertical surface against a gravitational force of about 1G in an atmosphere saturated with the solvent in 1 hour at a temperature of about 15° C. to about 25° C., e.g., 20±5° C.

In some embodiments, the binderless porous ceramic material includes: a surface area of about 1.5 m² to 100 m², about 10 m² to about 1500 m², or about 70 m² to about 1000 m² per square meter of projected substrate area; a surface area of about 15 m² to about 1500 m², or about 50 m² to about 700 m² per gram of ceramic material; mean pore diameter of about 5 nm to about 200 nm, about 2 nm to about 20 nm, or about 4 nm to about 11 nm; thickness up to about 100 micrometers, up to about 50 micrometers, up to about 25 micrometers, up to about 20 micrometers, or about 0.2 micrometers to about 25 micrometers; a porosity of about 5% to about 95%, about 10% to about 90%, about 30% to about 70%, about 30% to about 95%, or greater than about 10%; a void volume of about 100 mm³/g to about 7500 mm³/g as determined by mercury intrusion porosimetry; or any combination thereof.

In some embodiments, the substrate includes aluminum, an aluminum alloy, a steel alloy, an iron alloy, zinc, a zinc alloy, copper, a copper alloy, nickel, a nickel alloy, titanium a titanium alloy, other useful engineering alloys, glass, a polymer, a co-polymer, or plastic.

In some embodiments, the ceramic material (e.g., metal oxide, metal hydroxide, and/or hydrates thereof) includes one or more of zinc, aluminum, manganese, magnesium, cerium, copper, gadolinium, tungsten, tin, lead, and cobalt. In some embodiments, the ceramic material includes a transition metal, a Group II element, a rare-earth element (e.g., lanthanum, cerium gadolinium, praseodymium, scandium, yttrium, samarium, or neodymium), aluminum, tin, zinc, or lead.

In certain embodiments, the binderless porous ceramic surface modification material includes: a mixture of zinc and aluminum oxides and/or hydroxides; a mixture of manganese and magnesium oxides and/or hydroxides; manganese oxide and/or hydroxide; aluminum oxide and/or hydroxide; a mixed metal manganese oxide and/or hydroxide; a mixture of magnesium and aluminum oxides and/or hydroxides; magnesium oxide and/or hydroxide; a mixture of magnesium, cerium, and aluminum oxides and/or hydroxides; a mixture of zinc, praseodymium, and aluminum oxides and/or hydroxides; a mixture of cobalt and aluminum oxides and/or hydroxides; a mixture of manganese and aluminum oxides and/or hydroxides; a mixture of cerium and aluminum oxides and/or hydroxides; a mixture of zinc and aluminum oxides and/or hydroxides; a mixture of Zn-aluminates; a mixture containing any and all phases (e.g., one or more phases) containing Zn, Al and oxygen; or zinc oxide and/or hydroxide; or hydrate(s) of any of the above compounds or mixtures. In some embodiments, the substrate includes aluminum, iron, nickel, titanium, or copper.

In some embodiments, the binderless porous ceramic surface modification material provides one or more functional characteristic which is enhanced relative to an identical substrate that does not include the ceramic material, such as, but not limited to, a functional characteristic selected from wettability, hardness, elasticity, a mechanical, electrical, piezoelectric, optical, adhesion, or thermal property, microbial affinity or resistance, alteration of biofilm growth (e.g., resistance to or reduction of biofilm growth), catalytic activity, permeability, aesthetic appearance, liquid repellency, and corrosion resistance, or a combination of two or more of any of these functional characteristics. In some embodiments, the ceramic material provides enhanced wettability, corrosion resistance, adhesion, and/or optical properties, in comparison to an identical substrate that does not include the ceramic material.

In some embodiments, the binderless porous ceramic surface modification material includes an open cell porous structure. In open cells, interstitial pores are in connection with adjacent pores. In other embodiments, the surface modification material includes closed cells, in which each interstitial pore is discrete and completely surrounded by solid material (e.g., encapsulated by the surrounding solid material). In some embodiments, the binderless porous ceramic surface modification material includes both open cell and closed cell pores. In some embodiments, the binderless porous ceramic surface modification material includes open cells in which at least a portion of the open cells are open at the surface of the ceramic material, i.e., open to and/or in contact with the surrounding environment. In embodiments of the invention described herein, open cells can be unfilled or can be partially, substantially, or completely filled with one or more gas, liquid, or solid substance, or combinations thereof.

In some embodiments, the binderless porous ceramic surface modification material includes pores that are partially or completely, or substantially, filled with a gas, liquid, or solid substance, or combinations thereof. In some embodiments, the ceramic material includes pores that are less than 50% filled with a liquid and/or contains a liquid that is not stably contained or retained within the pores. In some embodiments, the ceramic material includes pores that are about 10% to about 25%, or any of about 5%, 10%, 15%, 20%, 25%, 30%, 35%, 40%, or 45%, or any of about 5%, 10%, 15%, 20%, 25%, 30%, 35%, 40%, or 45% to about 50% filled with a liquid.

In some embodiments, the binderless porous ceramic surface modification material includes pores that are filled with a mixture of a first material (e.g., a first substance) and a second material (e.g., a second substance), wherein the pores are first partially filled with the first material and then partially or completely filled with the second material. In some embodiments, one or more functional characteristic of the ceramic material is altered by inclusion of the first and/or second material. In some embodiments, the one or more functional characteristic (e.g., a thermal property and/or conductivity) of the ceramic material is tunable by varying the amount or composition of the first and/or second material. In some embodiments, the tunable characteristic includes a wettability, hardness, elasticity, mechanical, electrical, piezoelectric, optical, adhesion, or thermal property, microbial affinity or resistance, alteration of biofilm growth (e.g., resistance to or reduction of biofilm growth), catalytic activity, permeability, aesthetic appearance, liquid repellency, and/or corrosion resistance. In some embodiments, the first material interacts with the second material in a synergistic manner to alter one or more functional characteristic (e.g., one or more functional activity as described above) of the surface modification material.

In some embodiments, the gas, liquid, or solid substance inside the pores interacts with the substrate, thereby providing one more functionality such as fluid wicking, capillary climb, enhanced adhesion, thermal resistance, thermal conductance, corrosion resistance, and/or liquid repellency. In some embodiments, moisture in the environment interacts with the gas, solid, or liquid substance inside the pores, thereby providing one or more functionality such as modulated evaporation rate, corrosion protection of the substrate, and/or wettability enhancement.

In some embodiments, the binderless porous ceramic surface modification material includes one or more property such as wettability, hardness, elasticity, microbial affinity or resistance, alteration of biofilm growth, catalytic activity, corrosion resistance, aesthetic appearance, optical absorption, light trapping, and permeability.

In some embodiments, the binderless porous ceramic surface modification material further includes a layer of a top surface material over the ceramic material. In some embodiments, the top surface material provides a functionality such as, but not limited to, wettability with a liquid or selective separation of compounds in a liquid. In some embodiments, the top surface material interacts with a gas, liquid, or solid substance inside the pores, thereby providing a functionality such as, but not limited to, thermal management, wettability, electrochemical reactivity modulation (e.g., corrosion or catalysis modulation, or energy storage), or mechanical property modulation. In one embodiment, the top surface material is the surrounding environment, such as air.

In some embodiments, the top surface material includes one or more organic functional group, such as an ammonium group (e.g., quaternary ammonium group), an alkyl group, a perfluoroalkyl group, a fluoroalkyl group, and/or a phenyl group. In some embodiments, the top surface material includes a polymer. In some embodiments, the top surface material includes a ceramic (e.g., a different ceramic than the binderless porous ceramic material on the substrate). In some embodiments, the top surface material includes quaternary ammonium groups that impart anti-microbial functions, alkyl chains (e.g., alkyl groups) that impart water repellency and/or hydrocarbon affinity, perfluoroalkyl groups that impart water and/or oil repellant functions, a polymer that imparts an improved mechanical property function, and/or a ceramic that imparts an improved aesthetic performance or function, optoelectronic performance or function, and/or anti-corrosive performance or function.

In some embodiments, a gas, liquid, or solid substance inside the pores of the binderless porous ceramic material interacts with the ceramic material, thereby providing one or more functionality, such as, but not limited to, enhanced wettability, hardness, elasticity, a mechanical, electrical, piezoelectric, optical, adhesion, or thermal property, microbial affinity or resistance, alteration of biofilm growth (e.g., resistance to or reduction of biofilm growth), catalytic activity, permeability, aesthetic appearance, liquid repellency, and/or corrosion resistance, in comparison to a substrate that does not include the binderless porous ceramic material or in comparison to the binderless porous ceramic material without the gas, liquid or solid substance inside the pores.

In some embodiments, a gas, liquid, or solid substance inside the pores interacts with moisture in the environment (for example, a humid air environment), thereby providing one or more functionality, such as, but not limited to, modulated evaporation rate, condensation, or water crystallization, corrosion protection of the substrate, and/or wettability enhancement, in comparison to a substrate that does not include the binderless porous ceramic material or in comparison to the binderless porous ceramic material without the gas, liquid, or solid substance inside the pores.

In some embodiments, the binderless porous ceramic surface modification material is a completely or substantially filled porous structure, wherein the pores are completely or substantially filled with a second ceramic material (e.g., a ceramic material that is the same as or different from the binderless porous ceramic material on the substrate) or a polymer. “Substantially” filled may be any of about at least about 85%, 87%, 90%, 95%, 98%, or 99% filled.

In some embodiments, the binderless porous ceramic surface modification material is a partially filled porous structure. For example, the pores may be partially filled with a second ceramic material (e.g., a ceramic material that is different from the binderless porous ceramic material) or with a molecule with a head group and a tail group (for example, wherein the head group includes a silane group, a phosphonate group, a phosphonic acid group, a carboxylic acid group, a vinyl group, an alcohol group, a hydroxide group, a thiolate group, a thiol group, and/or an ammonium group (e.g., a quaternary ammonium group), and wherein the tail group includes a hydrocarbon group, a fluorocarbon group, a vinyl group, a phenyl group, an epoxide group, an acrylic group, an acrylate group, a hydroxyl group, a carboxylic acid group, a thiol group, and/or a quaternary ammonium group.

In some embodiments, the binderless porous ceramic surface modification material provides an asymmetric pore structure with respect to ceramic thickness from the substrate. For example, the pore size distribution may be characterized by the ratio of the first quartile pore diameter to the third quartile pore diameter as determined by BJH gas adsorption and desorption and may vary between about 0.2 and about 0.7 with respect to material thickness.

In another aspect, methods are provided for making binderless porous ceramic surface modification materials as described herein. In one embodiment, the method includes: (a) depositing the binderless ceramic porous material onto the substrate, for example, by dipping, spraying, roll coating, or otherwise contacting the substrate with an aqueous solution that includes one or more metal salt(s) and a chelating or complex forming agent, and controlling the pH and temperature to modulate the reaction rate to produce a ceramic material that includes a desired crystal structure, morphology, and/or surface porosity; (b) removing the substrate from the solution and heating the substrate to drive off moisture; and (c) optionally contacting (e.g., dipping) the substrate with a dilute solution of a functional molecule in a solvent, wherein the functional molecule is capable of chemically binding to the ceramic surface such that the pores are functionalized but remain open.

In some embodiments, the pores may be partially filled with a first material (e.g., a first substance), including dipping, spraying, roll coating, or otherwise contacting a substrate with a binderless porous (e.g., surface immobilized) ceramic surface into (i) a dilute solution of a functional molecule capable of chemically binding to the ceramic surface such that the pores are functionalized but remain open; and/or (ii) into a solution that includes one or more metal salt(s) and a chelating or complex forming agent, and driving off water; and optionally repeating (i) or (ii), and/or (i) and (ii), to stack multiple layers within the pores of various functional molecules and/or metal oxides.

In some embodiments, the pores are completely or substantially filled with a material (e.g., a substance), including dipping, spraying, roll coating, or otherwise contacting the substrate with a binderless porous (e.g., surface immobilized) ceramic surface or with partially filled pores into (i) a solution of a functional molecule capable of chemically binding to the ceramic surface such that the pores are filled with a substance; and/or (ii) into a solution that includes one or more metal salt(s) and a chelating or complex forming agent, and driving off water to completely fill the pores.

In another aspect, a composition as described herein (a binderless porous metal oxide surface modification material on a substrate) is adapted for use as a heat transfer surface, a fluid barrier, a filter, a fabric or textile, a corrosion barrier, a light absorbing surface, a catalyst, or a separation medium.

### BRIEF DESCRIPTION OF THE DRAWINGS

FIGS. 1A-1C show a scheme for testing the capillary rise of a surface immobilized surface material on a substrate, in this case, a planar substrate. The substrate is inserted into the container with a minimum liquid height sufficient to cover the bottom 5 mm to 1 cm of the substrate (1A). The liquid level on the substrate at the instant that it is put into the liquid is shown in (1B). h_{L} is the measured zero point for capillary rise, if the liquid never moves higher than h_{L}, it has a hᵣᵢₛₑ of zero. As time progresses, the liquid height for the disclosed surface immobilized porous ceramic metal oxides will flow up the length of the substrate. At a given time, the capillary rise (hᵣᵢₛₑ) can be determined by measuring the height the liquid traveled up the substrate from the top of the bulk liquid height as shown in (1C). The unmodified substrates have a capillary rise of zero, even after many hours.

FIG. 2 shows an example of multimodal pore size distributions with respect to differential intrusion volume as determined by mercury intrusion porosimetry measurements for a surface based on magnesium and aluminum oxides. The two peaks indicate there is a concentration of pores at 12.7 nm and at 5.5 nm. The pore geometry is assumed to be cylindrical.

FIG. 3A-3G show the spectra obtained using Grazing Incidence X-ray Diffraction with Cu K-alpha radiation. The measurement was a 2-theta scan with a scan range of 15 to 90 degrees and a 1 degree incidence angle. 3A was obtained from a surface material composed of zinc oxide. 3B was obtained from a surface material composed of zinc and aluminum double layered hydroxides. 3C was obtained from a surface material composed of manganese oxides. 3D was obtained from a surface material composed of a mixed manganese-aluminum hydroxide. 3E was obtained from a surface material composed of magnesium oxide. 3F was obtained from a surface material composed of manganese and aluminum double layered hydroxides. 3G was obtained from an uncoated surface composed of 99.999% aluminum.

FIGS. 4A-B shows the change in pore size distribution with the ceramic layer thickness. 4A is a plot of the normalized cumulative pore surface area versus pore diameter as determined by BJH of four samples of varying thickness. The “o” symbol represents a 0.68 micron thick ceramic layer. The “x” symbol represents a 0.93 micron thick ceramic layer. The “Δ” symbol represents a 1.15 micron thick ceramic layer. The “+” symbol represents a 2.06 micron thick ceramic layer. 4B is a plot of the ratio of first quartile pore size relative to the third quartile pore size, indicating that the ratio of pore sizes is decreasing with the thickness of the surface modification.

FIGS. 5A-B shows a ceramic surface before (5A) and after (5B) the partial filling of the pores with an alkyl phosphonic acid monolayer. The larger pores are maintained and slightly shifted to a smaller pore size due to the partial filling of the pores while any pore size less than about 2.7 nm was filled and no longer measured as determined by BJH adsorption/desorption. Note: the observed effect at around 50 angstroms corresponds to an experimental artifact during which liquid nitrogen probe condensed in the pores under non-equilibrium conditions rapidly evaporates.

### DETAILED DESCRIPTION

Porous metal oxide (e.g., metal oxide ceramic) compositions are provided herein. The surface modification materials described herein may impart desirable properties such as durability, thinness, conformality, and/or the ability to be functionalized in a variety of ways, which provides multifunctional benefits for a wide variety of applications.

The porous metal oxide compositions are deposited (e.g., coated) onto a substrate as a surface modification material without use of a binder. A binderless process for surface modification is advantageous because it leads to environmentally friendly processing with no volatile organic compound (VOC) solvents, allows for higher temperature operation, and allows for tailoring the structure-property relationships from the substrate to the end surface.

Binderless surface modification materials are provided, in which a binder is not used in the synthesis of the material and in which a binder is not present in the final composition that is deposited on the substrate. The morphology of the surface modification materials described herein provide functional properties independent from the chemical nature of the composition. The geometric surface (e.g., the pore structure) may impart a particular first property and the chemical composition may impart a second property, wherein the first and second properties are different and independent from one another. For example, in one non-limiting embodiment, the morphology of the composition may have the functional property of ability to control wettability of the surface, and the chemical composition may have a different functional property, such as reduction of corrosion. The structures have a measurable crystallinity and porosity, distinguishing from other amorphous nanomaterials, which may be exceptionally useful and beneficial for specific affinity, catalysis, electromagnetic, electromotive (piezo) applications.

Open pores may be unfilled or may be partially or completely filled with one or more material(s) or substance(s) that alter or enhance the functional properties of the surface modification material.

Additional layer(s) of material may further modify the functional properties. In some embodiments, the surface modification material is a capillary driven surface material, e.g., a very hydrophilic material. In other embodiments, the material is repellant to some liquids (e.g., water), but is capable of capillary action with other liquids (e.g., isopropanol). In other embodiments, the material can separate multiple components via capillary action (e.g., solvents or solutes from solutions).

### Definitions

Numeric ranges provided herein are inclusive of the numbers defining the range.

“A,” “an” and “the” include plural references unless the context clearly dictates otherwise.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.”

“Bimodal” refers to a distribution which contains two different modes that appear as two distinct peaks.

“Binder” or binding agent is any material or substance that holds or draws other materials together to form a cohesive whole mechanically, chemically, by adhesion or cohesion.

“Binderless” refers to absence of a binder, particularly with regard to an organic binder or resin (e.g., polymers, glues, adhesives, asphalt) or inorganic binder (e.g., lime, cement glass, gypsum, etc.).

“Capillary climb” refers to a surface tension driven flow of liquid up a sample (the capillary climb is parallel to, and opposite to, the direction of the force (vector) due to gravity) upon contact with a free surface of liquid as a result of the porous substrate.

“Ceramic” refers to a solid material comprising an inorganic compound of metal, non-metal, or ionic and covalent bonds.

“Contact angle” refers to the angle measured through a liquid between a surface and the liquid-vapor interface at the contacting surface.

A “conversion coating” refers to a surface layer in which reactants are chemically reacted with the surface to be treated that converts the substrate into a different compound. This process is typically not additive or a deposition.

“First quartile pore diameter” refers to the value of the pore diameter at which the cumulative pore surface area determined in the direction of increasing pore size is equivalent to 25% of the total cumulative pore surface area as determined by BJH gas adsorption/desorption measurements.

“Hydrophilic” refers to a surface that has a high affinity for water. Contact angles can be very low and/or immeasurable.

“Layered double hydroxide” refers a class of ionic solids characterized by a layered structure with the generic sequence [AcB Z AcB]ₙ, where c represents layers of metal cations, A and B are layers of hydroxide anions, and Z are layers of other anions and/or neutral molecules (such as water). Layered double hydroxides are also described in PCT Application No. PCT/US2017/052120, which is incorporate by reference herein.

“Mean” refers to the arithmetic mean or average.

“Mean pore diameter” is calculated using total surface area and total volume measurements from the Barrett-Joyner-Halenda (BJH) adsorption/desorption method as 4 times the total pore volume divided by the total surface area (4 V/A), assuming a cylindrical pore.

“Multimodal” refers to a distribution which contains more than one different mode that appears as more than one distinct peak.

“Permeability” in fluid mechanics is a measure of the ability of a porous material to allow fluids to pass through it. The permeability of a medium is related to the porosity, but also to the shapes of the pores in the medium and their level of connectedness.

“Pore size distribution” refers to the relative abundance of each pore diameter or range or pore diameters as determined by mercury intrusion porosimetry (MIP) and Washburn's equation.

“Porosity” is a measure of the void (i.e., “empty”) spaces in a material, and is a fraction of the volume of voids over the total volume, between 0 and 1, or as a percentage between 0% and 100%. Porosities disclosed herein were measured by mercury intrusion porosimetry.

“Porous” refers to spaces, holes, or voids within a solid material.

“Superhydrophobic” refers to a surface that is extremely difficult to wet. The contact angle of a water droplet on a superhydrophobic material here a superhydrophobic surface refers to contact angles >150°. Highly hydrophobic contact angles are >120°.

“Surface area per square meter of projected substrate area” refers to the actual measured surface area, usually measured in square meters, divided to the surface area of the substrate if it were atomically smooth (no surface roughness), also typically in square meters.

“Synergy” or “synergistic” refers to the interaction or cooperation between two or more substances, materials, or agents to produce a combined effect that is greater (positive synergy) or lesser (negative synergy) than the sum of their separate, individual effects.

“Thickness” refers to the length between the surface of the substrate and the top of the surface modification (e.g., ceramic) material.

“Third quartile pore diameter” refers to the value of the pore diameter at which the cumulative pore surface area determined in the direction of increasing pore size is equivalent to 75% of the total cumulative pore surface area as determined by BJH gas adsorption/desorption measurements.

“Tortuosity” refers to the fraction of the shortest pathway through a porous structure Δl and the Euclidean distance between the starting and end point of that pathway Δx.

“Tunable” refers to the ability of a function, characteristic, or quality of a material to be changed or modified.

### Compositions

Porous ceramic (e.g., metal oxide and/or metal hydroxide) surface modification compositions are provided herein. The compositions are provided as surface modification material on the surface of a substrate, for example, a surface-immobilized material. In some embodiments, the porous ceramic material includes a metal oxide and/or hydroxide ceramic, for example, a single metal or mixed metal oxide and/or hydroxide ceramic. In some embodiments, the porous ceramic material includes a metal hydroxide and/or hydroxide ceramic, for example, a single metal or mixed metal oxide and/or hydroxide ceramic. In some embodiments, the porous ceramic material includes a metal oxide and a metal hydroxide ceramic, wherein the metal oxide and the metal hydroxide include the same or different single metal or mixed metal. In some embodiments, the porous ceramic material includes a metal oxide and/or a metal hydroxide ceramic, wherein the substrate is hydrated by water or other compounds resulting in a change of surface energy and potentially the ratio of metal oxide to metal hydroxide composition of the ceramic. In some embodiments, the porous ceramic material includes a metal hydroxide, wherein at least a portion of the metal hydroxide is in the form of a layered double hydroxide, e.g., at least about 5%, 10%, 15%, 20%, 25%, 30%, 35%, 40%, 45%, 50%, 55%, 60%, 65%, 70%, 75%, 80%, 85%, 90%, or 95% of the metal hydroxide is layered double hydroxide.

In some embodiments of the compositions described herein, a “metal oxide” or “metal hydroxide” may be in the form of a hydrate of a metal oxide or metal hydroxide, respectively, or a portion of the metal oxide or metal hydroxide may be in the form of a hydrate of a metal oxide or metal hydroxide, respectively.

A mixed metal oxide or mixed metal hydroxide may include, for example, oxides or hydroxides, respectively, of more than one metal, such as, but not limited to, iron, cobalt, nickel, copper, manganese, chromium, titanium, vanadium, zirconium, molybdenum, tantalum, zinc, lead, tin, tungsten, cerium, praseodymium, samarium, gadolinium, lanthanum, magnesium, aluminum, or calcium.

The surface modification materials (binderless porous ceramic materials) herein are deposited onto a substrate without a binder. In some embodiments, a surface modification material as described herein is immobilized on the substrate.

In some embodiments, the ceramic material has an open cell porous structure, for example, characterized by one or more of: ability to effect capillary rise of a liquid having a low surface tension (e.g., less than about 25 mN/m, such as isopropanol) at greater than about 5 mm up a surface against gravity in a closed container in 1 hour; surface area of about 0.1 m²/g to about 10,000 m²/g; mean pore size of about 10 nm to about 1000 nm or about 1 nm to about 1000 nm; pore volume as measured by mercury (Hg) intrusion porosimetry of about 0 to about 1 cc/g; and tortuosity of about 1 to about 1000 as defined by the length of a fluid path to the shortest distance, the “arc-chord ratio”; and/or permeability of about 1 to about 10,000 millidarcy.

The binderless ceramic surface modification material is porous, with a porosity of about 5% to about 95%. In some embodiments, the porosity may be any of at least about or greater than about 5%, 10%, 15%, 20%, 25%, 30%, 35%, 40%, 50%, 55%, 60%, 65%, 70%, 75%, 80%, 85%, 90%, or 95%. In some embodiments, the porosity is about 10% to about 90%, about 30% to about 90%, about 40% to about 80%, or about 50% to about 70%.

The binderless porous surface modification material is porous, with a permeability of about 1 to 10,000 millidarcy. In some embodiments, the permeability may be any of at least about 1, 10, 100, 500, 1000, 5000, or 10,000 millidarcy. In some embodiments, the permeability is about 1 to about 100, about 50 to about 250, about 100 to about 500, about 250 to about 750, about 500 to about 1000, about 750 to about 2000, about 1000 to about 2500, about 2000 to about 5000, about 3000 to about 7500, about 5000 to about 10,000, about 1 to about 1000, about 1000 to about 5000, or about 5000 to about 10,000 millidarcy.

In some embodiments, the binderless porous ceramic material includes a void volume of about 100 mm³/g to about 7500 mm³/g, as determined by mercury intrusion porosimetry. In some embodiments, the void volume is any of at least about 100, 200, 300, 400, 500, 600, 700, 800, 900, 1000, 1500, 2000, 2500, 3000, 3500, 4000, 4500, 5000, 5500, 6000, 6500, 7000, or 7500 mm³/g. In some embodiments, the void volume is any of about 100 to about 500, about 200 to about 1000, about 400 to about 800, about 500 to about 1000, about 800 to about 1500, about 1000 to about 2000, about 1500 to about 3000, about 2000 to about 5000, about 3000 to about 7500, about 250 to about 5000, about 350 to about 4000, about 400 to about 3000, about 250 to about 1000, about 250 to about 2500, about 2500 to about 5000, or about 500 to about 4000 mm³/g. 1701 A binderless porous ceramic surface modification material as disclosed herein may be characterized by its interaction with liquid materials. As previously noted, the surface modification material may be characterized the ability to effect capillary rise of a liquid having a low surface tension (e.g., less than about 25 mN/m, such as isopropanol) at greater than about 5 mm up a surface against gravity in a closed container in 1 hour. Other solvents with surface tension less than about 25 mN/m at 20° C. of may be used including, but not limited to, Perfluorohexane, Perfluoroheptane, Perfluorooctane, n-Hexane (HEX), Polydimethyl siloxane (Baysilone M5), tert-Butylchloride, n-Heptane, n-Octane (OCT), Isobutylchloride, Ethanol, Methanol, Isopropanol, 1-Chlorobutane, Isoamylchloride, Propanol, n-Decane (DEC), Ethylbromide, Methyl ethyl ketone (MEK), n-Undecane, Cyclohexane. Solvents with Other solvents with surface tension at 20° C. of >25 mN/m may be used including: Acetone (2-Propanone), n-Dodecane (DDEC), Isovaleronitrile, Tetrahydrofuran (THF), Dichloromethane, n-Tetradecane (TDEC), sym-Tetrachloromethane, n-Hexadecane (HDEC), Chloroform, 1-Octanol, Butyronitrile, p-Cymene, Isopropylbenzene, Toluene, Dipropylene glycol monomethylether, 1-Decanol, Ethylene glycol monoethyl ether (Ethyl Cellosolve), 1,3,5-Trimethylbenzene (Mesitylene), Benzene, m-Xylene, n-Propylbenzene, Ethylbenzene, n-Butylbenzene, 1-nitro propane, o-Xylene, Dodecyl benzene, Fumaric acid diethylester, Decalin, Nitroethane, Carbon disulfide, Cyclopentanol, 1,4-Dioxane, 1,2-Dichloro ethane, Chloro benzene, Dipropylene glycol, Cyclohexanol, Hexachlorobutadiene, Bromobenzene, Pyrrol (PY), N,N-dimethyl acetamide (DMA), Nitromethane, Phthalic acid diethylester, N,N-dimethyl formamide (DMF), Pyridine, Methyl naphthalene, Benzylalcohol, Anthranilic acid ethylester, Iodobenzene, N-methyl-2-pyrrolidone, Tricresylphosphate (TCP), m-Nitrotoluene, Bromoform, o-Nitrotoluene, Phenylisothiocyanate, a-Chloronaphthalene, Furfural (2-Furaldehyde), Quinoline, 1,5-Pentanediol, Aniline(AN), Polyethylene glycol 200 (PEG), Anthranilic acid methylester, Nitrobenzene, a-Bromonaphthalene (BN), Diethylene glycol (DEG), 1,2,3-Tribromo propane, Benzylbenzoate (BNBZ), 1,3-Diiodopropane, 3-Pyridylcarbinol (PYC), Ethylene glycol (EG), 2-Aminoethanol, sym-Tetrabromoethane, Diiodomethane (DI), Thiodiglycol (2,2′-Thiobisethanol) (TDG), Formamide (FA), Glycerol (GLY), Water (WA), and Mercury

The binderless porous ceramic surface modification material may possess the ability to effect capillary rise of water, at various temperatures. These materials may have the ability to separate miscible materials and binary azeotropes, such as ethanol-water, ethyl acetate-ethanol, or butanol-water, to break ternary azeotropes, or to remove amyl alcohol from mixtures including ethanol and water.

The substrate on which the binderless porous ceramic surface modification material is deposited (e.g., immobilized) may be composed of any material suitable for the structural or functional characteristics, or functional application of use, of the surface modification composition. In some embodiments, the substrate is aluminum or contains aluminum (e.g., an aluminum alloy), a steel alloy, zinc, a zinc alloy, copper, a copper alloy, glass, a polymer, a co-polymer, or plastic. In some embodiments, the substrate includes a metal, and the primary metal in the ceramic material is different than the primary metal in the substrate. A primary metal is a metal that is at least about 50%, 60%, 70%, 80%, 90%, or 95% of the total metal in the substrate or the ceramic material, e.g., as determined by x-ray diffraction on an atomic metals basis. Examples of substrate primary metals include, but are not limited to, aluminum, iron, copper, zinc, nickel, titanium, and magnesium. Examples of ceramic primary metals include, but are not limited to, zinc, aluminum, manganese, magnesium, cerium, copper, gadolinium, tungsten, tin, lead, and cobalt.

In some embodiments, the substrate includes a metal that is able to react (e.g., dissolve) under reaction conditions that allow for local dissolution of the substrate metal, and the substrate metal is incorporated into the binderless porous ceramic material. For example, an aluminum substrate may provide aluminum (e.g., Al²⁺) that is incorporated into the binderless porous ceramic material as the ceramic material is deposited on the substrate.

The binderless porous ceramic surface modification material includes one or more metal oxide and/or metal hydroxide (and/or hydrates thereof). Non-limiting examples of metals that may be included in the ceramic compositions disclosed herein include: zinc, aluminum, manganese, magnesium, cerium, copper, gadolinium, tungsten, tin, lead, and cobalt. In some embodiments, the ceramic material includes a transition metal, a Group II element, a rare-earth element (e.g., lanthanum, cerium gadolinium, praseodymium, scandium, yttrium, samarium, or neodymium), aluminum, tin, or lead. In some embodiments, the ceramic material includes two or more metal oxides (e.g., a mixed metal oxide) including but not limited to zinc, aluminum, manganese, magnesium, cerium, praseodymium, and cobalt.

In some embodiments, the binderless porous ceramic surface modification material includes: a mixture of zinc and aluminum oxides and/or hydroxides; a mixture of ZnO and Al₂O₃, and Zn-aluminates; mixtures of materials comprising any/all phases comprising Zn, Al, and oxygen; a mixture of manganese and magnesium oxides and/or hydroxides; manganese oxide; aluminum oxide; a mixed metal manganese oxide and/or hydroxide; a mixture of magnesium and aluminum oxides and/or hydroxides; a mixture of magnesium, cerium, and aluminum oxides and/or hydroxides; a mixture of zinc, gadolinium, and aluminum oxides and/or hydroxides; a mixture of cobalt and aluminum oxides and/or hydroxides; a mixture of manganese and aluminum oxides and/or hydroxides; a mixture of cerium and aluminum oxides and/or hydroxides; a mixture of iron and aluminum oxides and/or hydroxides; a mixture of tungsten and aluminum oxides and/or hydroxides; a mixture of tin and aluminum oxides; tungsten oxide and/or hydroxide; magnesium oxide and/or hydroxide; manganese oxide and/or hydroxide; tin oxide and/or hydroxide; or zinc oxide and/or hydroxide.

In some embodiments, at least one metal in the binderless porous ceramic material is in the 2⁺ oxidation state.

In some embodiments, the binderless porous ceramic surface modification material includes one or more oxide and/or hydroxide of zinc, aluminum, manganese, magnesium, cerium, gadolinium, and cobalt, and the substrate is aluminum or an aluminum alloy.

In some embodiments, the binderless porous ceramic surface modification material is superhydrophobic. In some embodiments, the surface modification material is highly hydrophobic. In some embodiments, the surface modification material includes one or more functional characteristic selected from wettability, hardness, elasticity, mechanical, electrical, piezoelectric, electromagnetic, optical, adhesion, or thermal properties, microbial affinity or resistance, alteration of biofilm growth, catalytic activity, permeability, aesthetic appearance, and corrosion resistance, in comparison to a substrate that does not include the ceramic material.

The pores of the binderless porous ceramic surface modification material may include open cells filled with one or more gas, may include partially filled cells (e.g., partially filled with one or more solid material(s)), or may include completely or substantially filled cells (e.g., completely or substantially filled with one or more liquid and/or solid material(s)). In some embodiments, the pores are partially, substantially, or completely filled with a gas, liquid, or solid substance, or combinations thereof.

In some embodiments, the binderless porous ceramic surface modification may be used to measure, characterize, modulate, or separate solvents.

In some embodiments, the pores are partially filled with a first material and then partially or completely filled with a second material. In some embodiments, the second material is added as a layer of material over partially filled pores. In some embodiments, the first material is a gas, solid, or liquid, or combination of gas, liquid, and/or solid substance(s). In some embodiments, the second material is a gas, solid, and/or liquid substance(s), or the environment (e.g., air). Examples include, and functions thereby imparted include changes in the porosity, wicking, repellency and/or wetting behavior; changes in the composite (comprising the porous material and second material) to modify electrical/dielectric properties, to modify mechanical properties such as abrasion resistance, hardness, toughness, tactile feel, elastic modulus, yield strength, yield stress, Young's modulus, surface (compressive or tensile) stress, and/or elasticity; changes in thermal properties such as thermal diffusivity, conductivity, thermal expansion coefficient, thermal interface stress, and/or thermal anisotropy; modification of optical properties such as emissivity, color, reflectivity, and/or absorption coefficients; modification of chemical properties such as corrosion, catalysis, reactivity, inertness, compatibility, fouling resistance, ion pump blocking, microbial resistance, and/or microbial compatibility; and/or as a substrate for biocatalysis.

In some embodiments, the first material interacts with the second material in a positive or negative synergistic manner to alter one or more functional characteristic of the ceramic material, such as, but not limited to, wettability, hardness, elasticity, a mechanical, electrical, piezoelectric, optical, adhesion, or thermal property, microbial affinity or resistance, alteration of biofilm growth, catalytic activity, permeability, aesthetic appearance, liquid repellency, and/or corrosion resistance.

Nonlimiting materials that may be used to partially or completely fill pores include molecules capable of binding to the surface such as molecules with a head group and a tail group wherein the head group is a silane, phosphonate or phosphonic acid, a carboxylic acid, vinyl, a hydroxide, a thiol, or ammonium compound. The tail group can include any functional group such as hydrocarbons, fluorocarbons, vinyl groups, phenyl groups, and/or quaternary ammonium groups. Other ceramic materials can also be deposited into the pores partially or completely. Polymers may also be deposited into the pores partially or completely. Ceramic materials may include, for example, one or more oxide of zinc, aluminum, manganese, magnesium, cerium, gadolinium, and cobalt. In addition, ceramic materials may include any solid material which can be added to the surface modification material, including an inorganic compound of metal, non-metal, or metalloid atoms primarily held in ionic and covalent bonds, such as, for example, clays, silicas, and glasses. Polymers may include, for example, natural polymeric materials such as hemp, shellac, amber, wool, silk, natural rubber, cellulose, and other natural fibers, sugars, hemi- and holo-celluloses, polysaccharides, and biologically derived materials such as extracellular proteins, DNA, chitin. Synthetic polymers include, for example, polymers and co-polymers containing polyethylene, polypropylene, polystyrene, polyvinyl chloride, synthetic rubber, phenol formaldehyde resin, (or Bakelite), neoprene, nylon, polyacrylonitrile, PVB, silicone, polyisobutylene, PEEK, PMMA, and PTFE.

In some embodiments, the pores are filled partially with a thin composite polymer layer to produce a surface modification material that has porosity and functionality provided by the polymer. In other embodiments, the pores are filled completely with a thick polymer layer to produce a surface modification material with a thick polymer layer that has composite properties of the porous base material and the polymer layer. A polymer as described in the compositions herein includes co-polymers.

In some embodiments, the pores are partially or completely filled with a layer of material deposited over the surface of the surface modification material. In some embodiments, a layer of material is deposited that adds one or more functional group(s) to the surface modification material, such as, but not limited to, ammonium groups (e.g., quaternary ammonium groups), alkyl groups, perfluoroalkyl groups, fluoroalkyl groups. In some embodiments, a polymer or ceramic layer is deposited. In one embodiment, a ceramic top surface layer is deposited which is the same or different ceramic than the ceramic of the binderless porous ceramic material on the substrate. Examples of functional group(s) and functions thereby imparted include quaternary ammonium groups for anti-microbial functions, alkyl chains for water repellency and hydrocarbon affinity, perfluoroalkyl groups for water and oil repellant functions, polymers for mechanical property function, other ceramics for aesthetic functions, optoelectronic functions, or anti-corrosive functions.

In some embodiments, the pores are partially or completely filled with a gas, liquid, or solid substance, or combinations thereof, and the composition further includes a layer of a top surface material over the ceramic material, and the top surface material imparts one or more functionality, such as, but not limited to, wettability with a liquid and/or selective separation of compounds in a liquid. In certain embodiments, the top surface material is a separate material from the substance with which the pores are partially, substantially, or completely filled, and does not itself fill or intrude into the pores. In some embodiments, the top surface material interacts with the substance(s) in the pores. For example, the top surface material may interact with the substance(s) in the pores to provide one or more functionality, such as, but not limited to, thermal management, electrochemical reactivity modulation, and/or mechanical property modulation. In certain embodiments, the top surface material is the surrounding environment with which the binderless porous ceramic material is in contact.

In some embodiments, the pores are substantially or completely filed with a polymer or with a ceramic material.

In some embodiments, a material in the pores interacts with the surface modification material. Examples of such materials and functions thereby imparted include the oxidation of the surface modification material by ambient liquid or vapor, the condensation of minor components (e.g., environmental pollutants), the capture or oxidation of hazardous environmental materials such as CO or H₂S from environmental air, and/or the collection and retention of materials (i.e., HPLC column coating) from an additive sample. For example, this could be used to make a reusable chemical sensor, e.g., the sample is cooled, condensation occurs, changing the electrical properties (in this case the environmental condensate might be a second (or third) material in the pores and then exposure to UV might be used to clean the material.

In some embodiments, moisture in the environment or added to the pores interacts with a material in the pores to modify the material in the pores or the surface modification material. Examples of such materials and functions thereby imparted include changes in wetting behavior, in optical properties, changes in oxidation state or reactivity, changes in the rate of evaporation, frosting, icing, or condensation.

In some embodiments, material in the pores may be designed to interact with the surface modification material to “tune” the properties of the overall surface. Examples of tunable properties includes, but are not limited to, wettability, hardness, microbial resistance, catalytic activity, corrosion resistance, color, and/or photochemical activity.

In some embodiments, a top layer of material is deposited onto the surface modification material. Examples of such top layer materials include, but are not limited to, quaternary ammonium groups for anti-microbial functions, alkyl chains for water repellency and hydrocarbon affinity, perfluoroalkyl groups for water and oil repellant functions, polymers for mechanical property function, other ceramics for aesthetic functions, optoelectronic functions, or anti-corrosive functions. Examples of functionalities imparted by such top layer materials include, but are not limited to, changes in the porosity, wicking, repellency, and/or wetting behavior; changes in the composite (including the porous material and second material) to modify electrical/dielectric properties, to modify mechanical properties such as abrasion resistance, hardness, toughness, tactile feel, elastic modulus, yield strength, yield stress, Young's modulus, surface (compressive or tensile) stress, tensile strength, compression strength, and/or elasticity; thermal properties such as thermal diffusivity, conductivity, thermal expansion coefficient, thermal interface stress, thermal anisotropy, to modify optical properties such as emissivity, color, reflectivity, and/or absorption coefficients, to modification of chemical properties such as corrosion, catalysis, reactivity, inertness, compatibility, fouling resistance, ion pump blocking, microbial resistance, and/or microbial compatibility; and/or as a substrate for biocatalysis.

In some embodiments, the binderless porous ceramic surface modification material and a material in the pores interact in a synergistic manner, for example, enhancing or reducing at least one functionality of the surface modification material and/or the material in the pores, in comparison to the functionality of the surface modification material and/or the material in the pores alone. In some embodiments, two or more materials in the pores interact in a synergistic manner, for example, enhancing or reducing at least one functionality of at least one material in the pores, in comparison to the functionality of that material alone.

In some embodiments, the binderless porous ceramic surface modification material is resistant to degradation by ultraviolet radiation, in comparison to the substrate material, such as a polymer or any of the substrate materials disclosed herein.

In some embodiments, the binderless porous ceramic surface modification material includes a thickness of about 0.5 micrometers to about 20 micrometers. In some embodiments, the binderless porous ceramic material includes a thickness of about 0.2 micrometers to about 25 micrometers. In some embodiments, the thickness is any of at least about 0.2, 0.5, 1, 2, 3, 4, 5, 6, 7, 8, 9, 10, 11, 12, 13, 14, 15, 16, 17, 18, 19, 20, 21, 22, 23, 24, or 25 micrometers. In some embodiments, the thickness is any of about 0.2 to about 0.5, about 0.5 to about 1, about 1 to about 5, about 3 to about 7, about 5 to about 10, about 7 to about 15, about 10 to about 15, about 12 to about 18, about 15 to about 20, about 18 to about 25, about 0.5 to about 15, about 2 to about 10, about 1 to about 10, about 3 to about 13, about 0.5 to about 15, about 0.5 to about 5, about 0.5 to about 10, or about 5 to about 15 micrometers.

In some embodiments, the binderless porous ceramic surface modification material is characterized by a water contact angle of about 0° to about 180°. In other embodiments, the water contact angle is less than about 30 degrees. In other embodiments the water contact angle is greater than about 150 degrees.

In some embodiments, the binderless porous ceramic surface modification material is asymmetric, for example, a pore morphology that is not spherical, cylindrical, cubic or otherwise ordered as having a well-defined, relatively constant, normal distribution of surface area to volume, as characterized a by a ratio of the pore diameter at the first quartile to the pore size at the third quartile as a function of the thickness of the binderless ceramic surface modification. In particular, the pore morphology is asymmetric about its center when compared to a spherical, cylindrical, or cubic structure. A nonlimiting example of asymmetric pores is depicted in PCT Application No. PCT/US19/39743, which is incorporated by reference herein in its entirety.

An asymmetric binderless porous ceramic surface modification material may be characterized by a broad pore size distribution that varies with distance from the substrate. In particular, the pore structure at a given distance from the substrate can be characterized locally, e.g., as described herein and has a different characterization at a different distance. The resulting asymmetry is determined in situ by the combination of substrate, ionic mobility, processing conditions such as temperature, pressure, and concentrations. The degree of asymmetry can be further modified through bulk means such as mixing, agitation, electric field modulation, and tank filtration, or through surface directed process means such as shear rates, impinging flows or surface charge modification and modulation. The asymmetry can be determined ex situ through a variety of means such as etching, track etching, ion beam milling, oxidation, photocatalysis, or through additional means. These approaches are to refer to materials which have a narrower, or symmetric pore structures, with thickness and/or pore depth, such as zeolites, track etched membranes, or expanded PTFE membranes.

In some embodiments, the binderless porous ceramic surface modification material does not include fluorine. In some of these embodiments, the non-fluorinated materials surprisingly outperform their fluorinated counterparts as measured by wettability parameters, contact angle, and capillary climb.

In some embodiments, the binderless porous ceramic surface modification material includes a surface area of about 1.1 m² to about 100 m² per square meter of projected substrate area. In some embodiments, the binderless porous ceramic material includes a surface area of about 10 m² to about 1500 m² per square meter of projected substrate area. In some embodiments, the surface area is any of at least about 10, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, or 1500 m² per square meter of projected substrate area. In some embodiments, the surface area is any of about 10 to about 100, about 50 to about 250, about 150 to about 500, about 250 to about 750, about 500 to about 1000, about 750 to about 1200, about 1000 to about 1500, about 70 to about 1000, about 150 to about 800, about 500 to about 900, or about 500 to about 1000 m² per square meter of projected substrate area.

In some embodiments, the binderless porous ceramic material includes a surface area of about 15 m² to about 1500 m² per gram of ceramic material. In some embodiments, the surface area is any of at least about 15, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, or 1500 m² per gram of ceramic material. In some embodiments, the surface area is any of about 15 to about 100, about 50 to about 250, about 150 to about 500, about 250 to about 750, about 500 to about 1000, about 750 to about 1200, about 1000 to about 1500, about 50 to about 700, about 75 to about 600, about 150 to about 650, or about 250 to about 700 m² per gram of ceramic material.

In some embodiments, the binderless porous ceramic surface modification material includes mesoporous mean pore sizes that range from about 2 nm to about 50 nm. In other embodiments, the mean pore sizes range from about 50 nm to about 1000 nm. In some embodiments, the binderless porous ceramic material includes a mean pore diameter of about 2 nm to about 20 nm. In some embodiments, the mean pore diameter is any of at least about 2, 3, 4, 5, 6, 7, 8, 9, 10, 11, 12, 13, 14, 15, 16, 17, 18, 19, or 20 nm. In some embodiments, the mean pore diameter is any of about 2 to about 5, about 4 to about 9, about 5 to about 10, about 7 to about 12, about 9 to about 15, about 12 to about 18, about 15 to about 20, about 4 to about 11, about 5 to about 9, about 4 to about 8, or about 7 to about 11 nm.

### Methods of Making Binderless Porous Metal Oxide Materials

A binderless ceramic porous surface modification material as described herein may be produced by a method that includes dipping a clean substrate into an aqueous solution with one or more metal salt(s) for an amount of time to achieve a desired thickness of a porous coating composition on the substrate. The solution may also contain a chelating or complex forming agent. pH, temperature, and deposition time (e.g., about 5 minutes to about 300 minutes) are suitable for the desired thickness, morphology, and surface porosity of the surface modification material to be produced. The pH of the solution may be adjusted across the range of 1 to 12 in order to adjust the characteristics (for example, desired crystal structure and/or surface porosity) of the surface modification by the addition of acidic or basic materials. The metal salt(s) may include, for example, salts of magnesium, aluminum, cerium, iron, cobalt, gadolinium, manganese, tungsten, zinc, and/or tin. The salts may be metal cation salts with anions of, for example, sulfates, nitrates, chlorides, or acetates. The anion in the metal cation salt may be, for example, nitrate, perchlorate, tetrafluoroborate, or hexafluorophosphate. The anion in the metal cation salt may be a halide. The anion in the metal cation salt may be, for example, chloride, bromide, or iodide. The anion in the metal cation salt may be a carboxylate. The anion in the metal cation salt may be, for example, acetate, propionate, butyrate, or isobutyrate. The anion in the metal cation salt may be a halogenated carboxylate. The anion in the metal cation salt may be, for example, trichloroacetate or trifluoroacetate. In other embodiments, sodium cation salts are used with metal anions such as, for example, sodium stannate. In some embodiments, the metal salt concentration is about 1 mM to about 5M in the aqueous solution. In some embodiments, a chelating or complex-forming agent such as, for example, citric acid, urea, higher amines, diamines, triamines, or tetraamines, thioglycerol, oleic acid, other fatty acids, polyols, Tween 80, other surfactants, or combinations thereof, is included at a concentration of about 1 mM to about 5M. In some embodiments, a reducing agent (e.g., a base), such as, for example, an amine (e.g., diamine (such as urea or ethylenediamine), triamine, tetraamine (such as hexamethylenetetramine) or an alkali metal salt or metal hydroxide, such as, for example, calcium hydroxide, is included. For example, a reducing agent may change the oxidation state of a metal from a higher oxidation state to a lower oxidation state (for example, Fe³⁺ to Fe²⁺). In some embodiments, the ratio of metal salt to reducing agent is about 2:1 to about 0.5:1.

In some embodiments, reaction conditions promote local dissolution of a metal of the substrate and incorporation into the binderless porous ceramic material. For example, local dissolution of aluminum from an aluminum containing substrate may contribute aluminum (e.g., Al²⁺) to the binderless porous ceramic material that is deposited onto the substrate.

In some embodiments, the substrate is cleaned to remove loose and lightly adhered debris by washing and rinsing and a variety of metal cleaning solutions or cleaning solutions outlined for particular substrates. A variety of process conditions are acceptable for the successful removal of loose and lightly adhered debris.

In some embodiments, the substrate is processed using an alkaline based cleaning solution to saponify and remove fats and oils from the substrates. One example is the use of caustic soda in an aqueous solution with a pH of approximately 11 or greater. In other embodiments, an alkaline cleaning solution is used that has a pH greater than about 9. Other embodiments may use alternative means of degreasing such as vapor or solvent based methods. A variety of process conditions are acceptable for the successful removal of surface fats and oils.

In some embodiments, the substrate is further prepared to homogenize the surface using known methods for treatment the surface through an alkaline etching of substrate materials. This process generates surface oxides and surface hydroxides, reaction products and intermetallic materials, some of which are insoluble in the etch solution and must be removed from the substrate by rinsing, mechanical means or by a process known in the industry as desmutting. Desmutting or deoxidizing solutions typically include acid solutions such as chromic, sulphuric, nitric or phosphoric acids or combinations therein. Ferric sulfate solutions may be employed. The desmutting solutions remove the reaction products, oxides, hydroxides, and intermetallic materials by solubilizing or mechanical removal (e.g., silicon containing particles). Many proprietary surface preparation materials are available. Other surface preparation options such as acid etching, electropolishing, ultrasonic treatment, or other surface finishing treatment preparatory methods that remove substrate oxides, hydroxides, reaction products, and intermetallic compounds, may be successfully employed. A variety of process conditions are acceptable for the successful surface preparation of the substrate and removal of smut.

In some embodiments, the substrate is processed using one or more processing steps in which the substrate reacts with the processing baths to form the nanostructured materials. The solutions described herein are aqueous based and include metal salt of about 1 mM to about 5M in the aqueous solution and/or chelating or complex forming agents such as polyols, polyethers, urea, secondary and higher amines, diamines, triamines, or tetraamines, at a concentration of about 1 mM to about 5M. Process conditions, not including hydrostatic pressures for differing tank depths, range from 65 to 200 kPa, and temperatures spanning the liquid phase equilibrium for these solutions which range from −20° C. to 190° C. depending on concentrations and compositions.

In some embodiments, the substrate is removed from the solution and heated at a temperature of about 100° C. to about 1000° C. for a period of about 0 hours to about 5 hours. In some embodiments, the substrate is removed from the solution and heated at a temperature of about 100° C. to about 1000° C. for a period of about 0 hours to about 24 hours to remove substantially all the water from the substrate and the metal oxide surface modification.

Optionally, the substrate is dipped into a dilute solution (e.g., less than about 2%, or about 0.001% to about 2%) of a functional molecule with an appropriate solvent that is capable of chemically binding to the ceramic surface such the pores are functionalized but remain open.

In some embodiments, the method includes partially filling pores with one, two, or more material(s). For example, the method includes (a) taking the substrate with a surface immobilized porous ceramic surface, dipping it into a dilute solution of a functional molecule capable of chemically binding to the ceramic surface such that the pores are functionalized but remain open, and/or (b) dipping the substrate into another solution to deposit further ceramic within the pores and on the surface as described above, and heating to drive off water as before; and optionally repeating (a) or (b) or (a) and (b) to stack multiple layers within the pores of various functional molecules and/or metal oxides. Other nonlimiting methods of introducing the first or second material may be deployed such as spraying, pouring, dropping, or vapor phase deposition.

In some embodiments, the method includes completely filling the pores with one or more material(s). For example, the method includes taking the substrate with a surface immobilized porous ceramic surface, and dipping it into a more concentrated solution of a functional molecule capable of chemically binding to the ceramic surface (e.g., about 1% to about 20%) such that the pores are filled with a substance; and/or dipping the substrate into another metal salt solution as described above and driving off water as described above to completely fill the pores. Other nonlimiting methods of introducing the pore filling material may be deployed such as spraying, pouring, dropping, or vapor phase deposition.

### Applications of Use

In various embodiments, the binderless porous ceramic surface modification materials described herein may be used in a variety of applications, such as, but not limited to, use as a heat transfer surface, a fluid barrier, a filter, a fabric or textile, and a separation medium.

In some embodiments, the binderless porous ceramic surface modification material is an anti-corrosive material.

In some embodiments, the binderless porous ceramic surface modification material is an anti-microbial material.

In some embodiments, the binderless porous ceramic surface modification material is a self-cleaning material. For example, the surface modification material provides a substantially water and lint free surface, i.e., does not accumulate debris from water accumulation and/or evaporation.

In some embodiments, the binderless porous ceramic surface modification material is “tunable” for a particular application of use. Material(s) that are used to fill the pores and/or layer over the surface material enhance the functionality of the surface modification material and/or provide additional functionality. Other properties may also be tunable by virtue of material filling pores and/or layered over the surface, such as color, e.g., red, green, white, black, brown.

In other embodiments, the material can separate multiple components via capillary action (i.e., solvents or solutes from solutions). The wicking action can quickly wick the solvent up the surface while allowing the solute to remain in solution. The surface is tunable to optimize the separation effectiveness.

The following examples are intended to illustrate, but not limit, the invention.

### EXAMPLES

### Example 1

Compositions comprising binderless porous ceramic materials on a substrate were prepared according to the following general procedure. The substrate assemblies were spot cleaned with isopropanol to remove any residual oils. Next, the parts were submerged in an alkali metal caustic etch bath at pH>11 at a temperature from about 20° C. to about 60° C. for about 5 minutes to about 20 minutes. The assemblies were then rinsed in distilled or deionized water to remove any residual caustic or loosely adhered material. Next, the parts were submerged in a non-coordinating oxidizing acid (such as nitric acid) solution with pH below 2 and temperature of about 20° C. to about 60° C. to remove the smut and/or deoxidize the substrate. The assemblies were then placed into the production bath containing 20-250 mM of metal nitrate (such as manganese (II) nitrate) or sulfates (such as manganese (II) sulfate) or mixed metal nitrates (such as manganese (II) nitrate and zinc nitrate, typically in a ratio from about 50:1 to about 1:50) or sulfates and a similar molar amount of a diamine (such as urea or ethylenediamine), triamine, or tetraamine (such as hexamethylenetetramine), typically in a ratio from about 2:1 to about 0.5:1, that were heated to a reaction temperature of about 50° C.-85° C. The assemblies were maintained in the bath for times ranging from about 5 minutes to about 3 hours. The assemblies were removed, rinsed in distilled or deionized water, and placed into an oven to dry and/or calcine at 50-600° C. for several minutes to several hours. This deposit step can optionally be repeated (with the same or different metal salt) before or after the drying step followed by another optional drying step, if desired. In some embodiments, the metal in the deposited coating can come from the substrate (such as the aluminum in the deposit comprising zinc and aluminum hydroxides/oxides). After cooling, the parts were further processed and/or tested as described in the examples below.

### Example 2

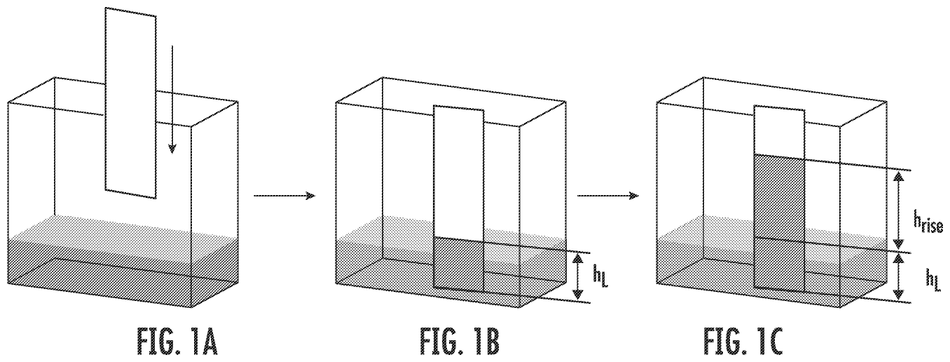

A clean 316 stainless steel tube was coated with a porous ceramic surface based on zinc oxide. The water contact angle was measured to be less than 5 degrees by the sessile drop method. The tube was then placed into a cup with about 1 centimeter of deionized water. After 30 seconds the capillary rise was measured to be >1 centimeter above the liquid level. A schematic representing this method is shown in FIGS. 1A-1C.

### Example 3

A clean 3003 aluminum plate was coated with a porous ceramic surface based on a mixture of zinc and aluminum oxides. The water contact angle was measured to be less than 5 degrees via the sessile drop method. The plate was then placed into a cup with about 1 centimeter of deionized water. After 30 seconds the capillary rise was determined to be about 0.5 centimeters above the liquid level, and after 3 minutes it had climbed >1 cm. The substrate was then dried and placed into a vial containing Vertrel SDG, a low surface tension cleaner containing a mixture of hydrofluorocarbons and 1,2-dichloroethylene. After 300 seconds, the Vertrel SDG liquid capillary rise was determined to be about 1 centimeter.

### Example 4

A clean 3003 aluminum plate was coated with a porous ceramic surface based on a mixture of magnesium and aluminum oxides. The water contact angle was measured to be less than 5 degrees. The plate was then placed into a cup with about 1 centimeter liquid height of deionized water. After 30 seconds the capillary climb was determined to be >2.5 centimeters above the liquid level, >5 cm after 3 minutes, and >8 cm after 10 minutes. The substrate was then dried and placed into a vial containing about 1 cm of Vertrel SDG, a low surface tension cleaner containing a mixture of hydrofluorocarbons and 1,2-dichloroethylene. After 600 seconds, the Vertrel SDG liquid climbed >1.4 centimeters above the liquid height.

### Example 5

A clean aluminum substrate was coated with a porous ceramic surface based on a mixture of magnesium and aluminum oxides. The mass of the substrate was measured before and after the application of the coating. The specific mass of the coating was determined to be about 3 g/m2 of substrate area. A cross-sectional scanning electron micrograph of the coating indicated that the coating thickness was about 2.5 microns. Based on the known theoretical density of the solid material, the surface is only about 40% as dense as a solid material (60% porosity).

### Example 6

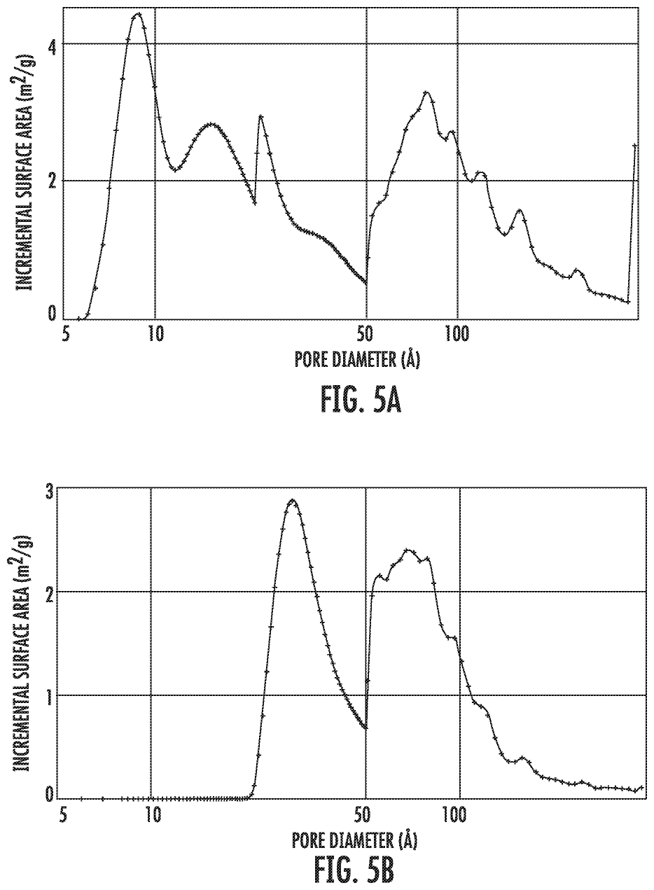

A clean 4006 aluminum foil substrate was coated with a porous ceramic surface based on a mixture of magnesium and aluminum oxides. Nitrogen BET surface area measurements indicated that the surface area is 1000 square meters per square meter of projected substrate surface area and that the mass specific surface area of the ceramic material is about 250 m²/g. BJH measurements indicate the smallest pores are about 0.6 nm in diameter The minimum pore diameter is shown in FIG. 5. Mercury porosimetry indicated that there was a bimodal pore size distribution with pore sizes concentrated at about 33 nm and 4.6 nm and. Mercury porosimetry indicates the material is 75% porous relative to the bulk oxide material.

### Example 7

A clean 3003 aluminum plate was coated with a porous ceramic surface based on a mixture of magnesium, cerium, and aluminum oxides. The water contact angle was measured to be less than 5 degrees. The plate was then placed into a cup with about 1 centimeter liquid height of deionized water. After 30 seconds the capillary climb was determined to be 1 centimeter above the liquid level and after 2 minutes the water climbed >2 cm above the liquid level.

### Example 8

A clean aluminum substrate was coated with a porous ceramic surface based on a mixture of zinc, gadolinium, and aluminum oxides. The water contact angle was measured to be less than 5 degrees. The plate was then placed into a cup with about 1-centimeter liquid height of deionized water. After 120 seconds the water climbed about 1 centimeter above the liquid level and after 10 minutes, the water climbed about 1.3 centimeters above the liquid level.

### Example 9

A clean 3003 aluminum plate was coated with a porous ceramic surface based on a mixture of magnesium and aluminum oxides. The water contact angle was measured to be less than 5 degrees. The plate was then placed into a cup with about 1 centimeter of a 0.2 volume percent Water-Glo® 802-p, a fluorescent dye, in deionized water. After about 15 minutes the water climbed about 6 centimeters above the liquid level while the dye only climbed about 1 cm above the liquid level.

### Example 10

A clean 3003 aluminum plate was coated with a porous ceramic surface based on a mixture of magnesium and aluminum oxides. The water contact angle was measured to be less than 5 degrees. The plate was then placed into a cup with 1 drop of green gel food color in 100 mL of deionized water. After 30 minutes the water climbed about 8 centimeters above the liquid level while the green food color only climbed <0.5 cm above the liquid level. A non-porous alumina plate was purchased as a control. It was cleaned by heating it to 500° C. for 1 hour to remove any organic contaminants. Neither the water nor the food coloring climbed above the liquid meniscus (about 2 mm above the liquid level) on the plate despite it having a water contact angle less than 5 degrees.

### Example 11

A vapor degreased 5000 series alloy aluminum mesh was coated with a porous ceramic surface based on a mixture of magnesium and aluminum oxides. The water contact angle was measured to be less than 5 degrees. The mesh was then placed into a cup with about 1 centimeter of liquid height of deionized water. After 30 seconds the water capillary climb was measured to be 6 centimeters above the liquid level. After 90 seconds, the water climbed 9 centimeters above the liquid level. A vapor degreased 5000 series alloy aluminum mesh that was uncoated was also dipped into the same deionized water bath as a control. There was no measurable liquid rise above the liquid level after 30 seconds, 2 minutes, or 80 minutes.

### Example 12

A clean 3003 aluminum plate was coated with a porous ceramic surface based on a mixture of cobalt and aluminum oxides. The sessile drop water contact angle was measured to be less than 5 degrees. The plate was then placed into a cup with about 1 centimeter of deionized water. After 15 seconds the capillary climb height was measured to be about 0.6 centimeters above the liquid level. After 300 seconds the capillary climb height was measured to be greater than 1.5 cm.

### Example 13

A clean 3003 aluminum plate was coated with a porous ceramic surface based on a mixture of manganese and aluminum oxides. The sessile drop water contact angle was measured to be less than 5 degrees. The plate was then placed into a cup with about 1 centimeter of deionized water. After 30 minutes the water capillary climb was measured to be 3 centimeters above the liquid level.

### Example 14

A clean 3003 aluminum plate was coated with a porous ceramic surface based on cerium oxides. The sessile drop water contact angle was measured to be less than 5 degrees. The plate was then placed into a cup with about 1.5 centimeters of liquid height of deionized water. After 30 seconds the water climbed 3 centimeters above the liquid level. As a control, a cerium-based conversion coating was applied to a 3003 aluminum plate by dipping the plate into a dilute solution of cerium nitrate of ˜1% for about 1 hour at about 55° C. This plate was then placed into a cup with about 1 centimeter of deionized water. After 2 minutes, the there was no measurable capillary climb above the liquid level.

### Example 15

A 99%+ theoretical density alumina plate (less than 1% porosity) was heated to 400° C. for 1 hour to remove any surface organic contaminants. The sessile drop water contact angle was measured to be less than 5 degrees. The plate was then placed into a cup with a liquid height of about 1 centimeter of deionized water. After 20 minutes the water did not climb above the meniscus (<3 mm) above the liquid level.

### Example 16

A clean 3003 aluminum plate was coated with a porous ceramic surface based on a mixture of magnesium and aluminum oxides. The surface was then functionalized using a dilute (<0.5%) solution of hexadecylphosphonic acid in isopropanol for 2-5 hours at room temperature. The substrate was then removed and allowed to dry at 105° C. for about 1 hour. The sessile drop water contact angle was measured to be greater than 165 degrees. The plate was then placed into a cup with about 5 centimeters of deionized water. After 30 seconds, the substrate was completely encapsulated in an air bubble and never touched the water. The substrate was removed completely dry and placed into a vial containing about 1 cm of Vertrel SDG, a low surface tension cleaner containing a mixture of hydrofluorocarbons and 1,2-dichloroethylene. After 30 seconds, the Vertrel SDG liquid capillary rise was measured to be 1 centimeter above the liquid height and about 1.5 cm above the liquid height after 15 minutes. The substrate was then allowed to dry and then placed into a vial containing a liquid height of about 1 cm of isopropanol. After 30 seconds the isopropanol climbed about 0.8 centimeters above the liquid height and about 2 cm after 20 minutes. The substrate was then allowed to dry and placed into a vial containing about 1 cm of mineral spirits. After 30 seconds the mineral spirits climbed 1 centimeters above the liquid level, 3 cm after 10 minutes and 7 cm after 90 minutes. The sessile drop water contact angle was measured after the submersion in the solvents, and it was still greater than 165 degrees.

### Example 17

A clean 4006 aluminum foil substrate was coated with a porous ceramic surface based on a mixture of magnesium and aluminum oxides. The surface was then functionalized using a dilute solution of hexadecylphosphonic acid in isopropanol, similar to the procedure in Example 16. Nitrogen BET surface area measurements indicated that the surface area is 300 to 500 square meters per square meter of projected substrate surface area and that the mass specific surface area of the ceramic material is 150 to 200 m²/g. Mercury porosimetry indicated that there is a bimodal pore size distribution with pore sizes concentrated at about 5 nm and about 30 nm. BJH measurements indicate the volume of pores smaller than 2.7 nm in diameter is effectively zero. This indicates that the smallest pores are 2.7 nm in diameter. Pore size distributions as determined by BJH adsorption measurements before and after the partial filling surface functionalization are shown in FIGS. 5A-5B. Additionally, mercury porosimetry indicates the material is 52% to 69% porous relative to the bulk oxide material.

### Example 18

A clean 4006 aluminum foil substrate was coated with a porous ceramic surface based on a mixture of magnesium, cerium and aluminum oxides. Krypton BET surface area measurements indicate that the surface area is about 200 square meters per square meter of projected substrate surface area.

### Example 19

A vapor degreased 5000 series alloy aluminum mesh was coated with a porous ceramic surface based on a mixture of magnesium and aluminum oxides. The surface was then functionalized using a dilute solution of hexadecylphosphonic acid in isopropanol, similar to the procedure in Example 16. The plate was then placed into a cup with about 5 centimeters of deionized water. After 30 seconds, the substrate was completely encapsulated in an air bubble, having never touched the liquid. The substrate was removed completely dry and placed into a vial containing about 1 cm of Vertrel SDG, a low surface tension cleaner containing a mixture of hydrofluorocarbons and 1,2-dichloroethylene. After 30 seconds, the Vertrel SDG liquid capillary height rise was measured to be about 2.5 centimeters above the liquid height, and 8 cm above the liquid height in 15 minutes. The substrate was then allowed to dry and then placed into a vial containing about 1 cm of isopropanol. After 30 seconds the isopropanol climbed 2 centimeters above the liquid height, and 6.5 cm in 15 minutes. The substrate was then allowed to dry and placed into a vial containing about 1 cm of mineral spirits. After 30 seconds the mineral spirits climbed 2.5 centimeters above the liquid level, and 7 cm after 15 minutes.

### Example 20

A clean 3003 aluminum plate was coated with a porous ceramic surface based on a mixture of magnesium and aluminum oxides. The surface was then functionalized using a solution of 1 to 5% perfluorodecyltriethoxysilane, 1 to 3% acetic acid, and 2-5% water with a balance of ethanol for 6 hours. The surface was then removed from the functionalization solution, rinsed with ethanol, and allowed to dry at 105° C. for 1 hour. The sessile drop water contact angle was measured to be greater than 160 degrees. The plate was then placed into a cup with about 5 centimeters of deionized water. After 30 seconds, the substrate was completely encapsulated in an air bubble. The substrate was then placed into a vial containing about 1 cm of isopropanol. After 300 seconds the isopropanol climbed about 1 centimeter above the liquid height.

### Example 21

A clean 304 stainless steel plate was coated with a zinc oxide porous ceramic surface. The surface was then functionalized using a dilute (about 0.1% to about 1%) solution of stearic acid in mineral spirits by dipping the surface into the solution for about 15 minutes to about 2 hours at room temperature. The surface was then removed and dried at room temperature. The contact angle was measured to be greater than 150 degrees. The plate was then placed into a cup with about 5 centimeters of deionized water. After 15 seconds, the substrate was still completely encapsulated in an air bubble. The substrate was removed and then placed into a vial containing a liquid height of about 1 cm of isopropanol. After 30 seconds the isopropanol climbed >1 centimeter above the liquid height.

### Example 22

A clean glass slide was coated with a porous zinc oxide ceramic surface. For this particular case the steps involving the caustic etch bath and the nitric acid bath were both skipped. The surface was then functionalized using a dilute solution hexadecylphosphonic acid, similar to the procedure in Example 16. The sessile drop water contact angle was measured to be greater than 160 degrees. The slide was then placed into a cup with a liquid height of about 1 centimeters of deionized water. After 30 seconds, the substrate was encapsulated in an air bubble. The substrate was removed and placed into a vial containing about 1 cm of isopropanol. After 30 seconds, the isopropanol liquid climbed about 1 cm above the liquid height.

### Example 23

A clean glass slide was coated with a porous zinc oxide ceramic surface. For this particular case the steps involving the caustic etch bath and the nitric acid bath were both skipped. The sessile drop water contact angle was measured to be less than 5 degrees. The plate was then placed into a cup with about 0.5 centimeter of deionized water. After about 10 seconds, the water capillary rise was measured to be 2 centimeters above the liquid height, the full length of the substrate.

### Example 24

A polypropylene piece was coated with a porous magnesium hydroxide ceramic surface. For this particular case the steps involving the caustic etch bath and the nitric acid bath were both skipped. The sessile drop water contact angle was measured to be less than 5 degrees. The plate was then placed into a cup with about 1 centimeter of deionized water. After 30 seconds, the water climbed >1 centimeter above the liquid height.

### Example 25

A clean 3003 aluminum plate was coated with a porous ceramic surface based on a mixture of magnesium and aluminum oxides. The sessile drop water contact angle was measured to be less than 5 degrees. The plate was then submersed into a dilute solution (˜0.1%) of polychloroprene in t-butyl acetate for about 1 to 2 hours at room temperature, removed, and allowed to dry at room temperature overnight. The sessile drop water contact angle was then measured to be above 150 degrees. The plate was then placed into a cup with about 1 centimeter of deionized water. After 30 seconds the substrate was encapsulated in an air bubble. The substrate was then placed into a vial containing about 1 cm of isopropanol. After about 300 seconds, the isopropanol climbed >1.2 centimeters above the liquid height.

### Example 26

A clean 3003 aluminum plate was coated with a porous ceramic surface based on a mixture of magnesium and aluminum oxides. The sessile drop water contact angle was measured to be less than 5 degrees. The plate was then submersed into a concentrated solution (˜2%) of polychloroprene in t-butyl acetate for 1 to 2 hours at room temperature, removed, and allowed to dry at room temperature overnight. The sessile water contact angle was then measured to be about 85 degrees. The plate was then placed into a cup with about 1 centimeter of deionized water. After 30 seconds there was no capillary climb. The substrate was then placed into a vial containing about 1 cm of isopropanol. After about 300 seconds, there was no capillary climb.

### Example 27

A roughened superhydrophobic surface made of zinc oxide on a 3003-aluminum substrate and functionalized with a monolayer of perfluorodecyltriethoxysilane, similar to the procedure in Example 20, was measured to have a contact angle of greater than 168 degrees. This substrate when dipped into water was encapsulated in an air bubble. The substrate was then dipped into solutions with a liquid height of about 1 cm of Vertrel SDG, isopropanol, and mineral spirits. None of these solutions had a measurable capillary climb above the liquid height on this substrate after 10 minutes. This shows that a roughened surface or contact angle alone is not sufficient to enable capillary climb.

### Example 28

A clean 3003 aluminum plate was coated with a porous ceramic surface based on a mixture of magnesium and aluminum oxides. The sessile drop water contact angle was measured to be less than 5 degrees. The bottom quarter of the plate was then submersed into a dilute solution (˜0.1%) of polychloroprene in t-butyl acetate and sealed in a vial. After 1 minute, a liquid wicked up the entire length of the surface (about 3 cm). The substrate was left in the solution for about 30 minutes, removed from the vial, and then then allowed to dry in air. The sessile drop water contact angle was then measured to be above 150 degrees for the portion submersed in the liquid and less than 5 degrees for the portion where the solution wicked upward.

### Example 29

A clean 3003 aluminum plate was coated with a porous ceramic surface based on a mixture of cerium and aluminum oxides. The contact angle was measured to be less than 5 degrees. The plate was then placed into a cup with a liquid height of about 1.5 centimeters of deionized water. After 30 seconds the water climbed 3 centimeters above the liquid level. A clean 3003 aluminum plate and this sample coated with a mixture of cerium and aluminum oxides were characterized for corrosion resistance using electrochemical impedance spectroscopy. The ceramic modified sample was shown to have a corrosion resistance 500× higher than the bare 3003 aluminum plate.

### Example 30

A clean 3003 aluminum plate is coated with a porous ceramic surface based on a mixture of tungsten and aluminum oxides. The sessile drop water contact angle is measured to be less than 5 degrees. The plate is then placed into a cup with a liquid height of about 1 centimeter of deionized water. After 30 minutes the water capillary rise measures to be 3 centimeters above the liquid level.

### Example 31

A clean 3003 aluminum plate is coated with a porous ceramic surface based on a mixture of tin and aluminum oxides. The sessile drop water contact angle is measured to be less than 5 degrees. The plate is then placed into a cup with about 1 centimeter of deionized water. After 30 minutes the water climbs 3 centimeters above the liquid level.

### Example 32

A clean 4006 aluminum foil substrate was coated with a porous ceramic surface based on a mixture of magnesium and aluminum hydroxides. Krypton BET surface area measurements indicate that the surface area is about 180 square meters per square meter of projected substrate surface area and that the mass specific surface area of the ceramic material is 67 m²/g. Mercury porosimetry indicates that the ceramic material comprises a void volume of 293 mm³/g. Mercury porosimetry indicates the material is 51% porous relative to the bulk oxide material.

### Example 33

A clean 4006 aluminum foil substrate was coated with a porous ceramic surface based on a mixture of manganese and aluminum oxides. Nitrogen BET surface area measurements indicated that the surface area was about 180 square meters per square meter of projected substrate surface area and that the mass specific surface area of the ceramic material was 110 m²/g. Mercury porosimetry indicated that there was a bimodal pore size distribution with pore sizes concentrated at 5.3 nm and 28 nm. Mercury porosimetry indicated that the ceramic material comprised a void volume of 670 mm³/g. Mercury porosimetry indicated the material was 77% porous relative to the bulk oxide material.

### Example 34

A clean 4006 aluminum foil substrate was coated with a porous ceramic surface based on a mixture of zinc and aluminum oxides. Nitrogen BET surface area measurements indicated that the surface area was about 160 square meters per square meter of projected substrate surface area and that the mass specific surface area of the ceramic material was 95 m²/g. Mercury porosimetry indicated that there was a bimodal pore size distribution with concentrations of pores at about 29 nm and at 4.8 nm. Mercury porosimetry indicated the material is 86% porous relative to the bulk oxide material.

### Example 35

A clean 4006 aluminum foil substrate was coated with a porous ceramic surface based on a mixture of manganese and aluminum hydroxides with no thermal treatment step. Nitrogen BET surface area measurements indicate that the surface area is about 110 square meters per square meter of projected substrate surface area and that the mass specific surface area of the ceramic material is 53 m²/g. Mercury porosimetry indicates that there is a multimodal pore size distribution with concentrations of pores at 27 nm, 9.4 nm, and 5.3 nm. Mercury porosimetry indicated that the ceramic material comprises a void volume of 540 mm³/g. Mercury porosimetry indicated that the ceramic material is 72% porous relative to the bulk oxide material.

### Example 36

A clean 4006 aluminum foil substrate was coated with a porous ceramic surface based on a mixture of magnesium and aluminum oxides. Nitrogen BET surface area measurements indicate that the surface area is 250 to 350 square meters per square meter of projected substrate surface area and that the mass specific surface area of the ceramic material was 183 m²/g. Mercury porosimetry indicates that there is a bimodal pore size distribution with pores sizes concentrated at about 28 nm and at about 5 nm Mercury porosimetry indicated that the ceramic material comprises a void volume of 951 mm³/g. Mercury porosimetry indicated that the ceramic material is 77% porous relative to the bulk oxide material.

### Example 37

A clean 4006 aluminum foil substrate was coated with a porous ceramic surface based on a mixture of magnesium and aluminum oxides. Nitrogen BET surface area measurements indicate that the surface area is about 1000 square meters per square meter of projected substrate surface area and that the mass specific surface area of the ceramic material was about 240 m²/g. Mercury porosimetry shows the intrusion volume for pores between 0.1 microns and 10 microns in diameter is 2.35 mL per square meter of substrate. Separately, a second clean 4006 aluminum foil substrate was coated with a porous ceramic surface based on a mixture of magnesium and aluminum oxides using identical processing conditions as the first sample. The surface pore structure of the second sample was then substantially filled using latex spray paint, applied according the manufacturer instructions. Nitrogen BET surface area measurements indicated that the surface area of the second sample was about 3 square meters per square meter of projected substrate surface area and that the mass specific surface area of the ceramic material was less than 0.1 m²/g. Mercury porosimetry of the second sample showed the intrusion volume for pores between 0.1 microns and 10 microns in diameter is 0.29 mL per square meter of substrate. This demonstrated that 87% of the pore volume in the range of 0.1 microns to 10 microns was filled using the spray paint.

### Example 38

A clean 4006 aluminum foil substrate with no coating material was analyzed. Krypton BET surface area measurements indicated that the surface area is about 0.036 m²/g. Mercury porosimetry indicated the material is less than 1% porous.

### Example 39

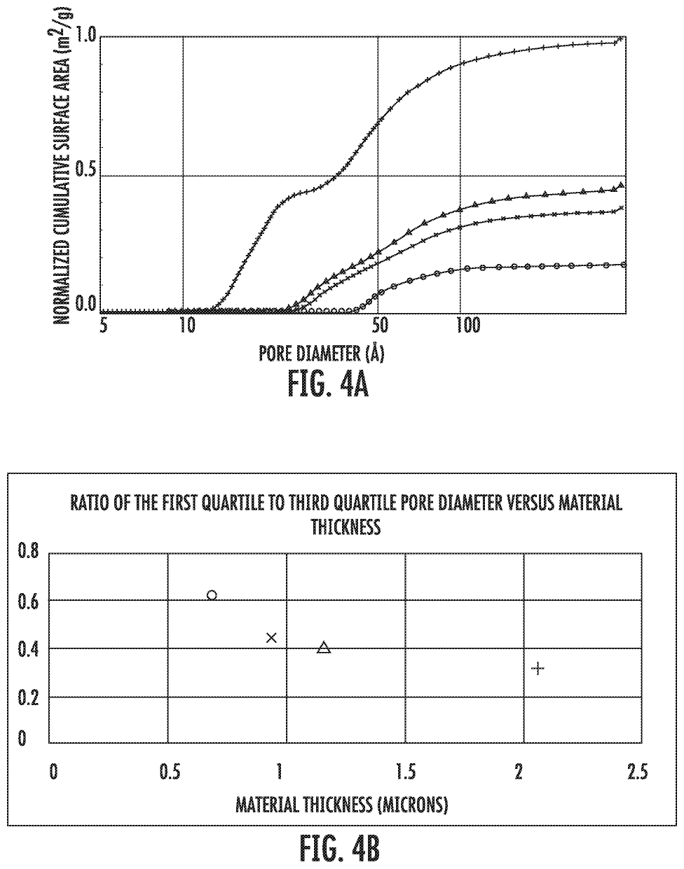

A clean 4006 aluminum foil substrate was coated with a porous ceramic surface based on a mixture of magnesium and aluminum oxides. The ratio of the first quartile pore diameter to the third quartile pore diameter as determined by BJH gas adsorption was found to be 0.63. Mercury porosimetry indicated that the ceramic material comprises a void volume of 3091 mm³/g. Mercury porosimetry indicated that the ceramic material is 92% porous relative to the bulk oxide material. Based on the measured void volume and the porosity, the ceramic material thickness was calculated to be 0.68 microns thick. Separately, a different clean 4006 aluminum foil substrate was coated with a porous ceramic surface based on a mixture of magnesium and aluminum oxides. The ratio of the first quartile pore diameter to the third quartile pore diameter as determined by BJH gas adsorption was found to be 0.45. Mercury porosimetry indicated that the ceramic material comprises a void volume of 2264 mm³/g. Mercury porosimetry indicated that the ceramic material is 89% porous relative to the bulk oxide material. Based on the measured void volume and the porosity, the ceramic material thickness was calculated to be 0.94 microns thick. Separately, a different clean 4006 aluminum foil substrate was coated with a porous ceramic surface based on a mixture of magnesium and aluminum oxides. The ratio of the first quartile pore diameter to the third quartile pore diameter as determined by BJH gas adsorption was found to be 0.41. Mercury porosimetry indicated that the ceramic material comprises a void volume of 1660 mm³/g. Mercury porosimetry indicated that the ceramic material is 86% porous relative to the bulk oxide material. Based on the measured void volume and the porosity, the ceramic material thickness was calculated to be 1.15 microns thick. Separately, a different clean 4006 aluminum foil substrate was coated with a porous ceramic surface based on a mixture of magnesium and aluminum oxides. The ratio of the first quartile pore diameter to the third quartile pore diameter as determined by BJH gas adsorption was found to be 0.32. Mercury porosimetry indicated that the ceramic material comprises a void volume of 1455 mm³/g. Mercury porosimetry indicated that the ceramic material is 84% porous relative to the bulk oxide material. Based on the measured void volume and the porosity, the ceramic material thickness was calculated to be 2.05 microns thick. These substrates were modified with the same ceramic surface, with the only difference being the thickness. These trends are depicted in FIGS. 4A-4B.

### Example 40

A clean 4006 aluminum foil substrate was coated with a porous ceramic surface based on a mixture of magnesium and aluminum oxides. Nitrogen BET surface area measurements indicate that the surface area is about 70 square meters per square meter of projected substrate surface area and that the mass specific surface area of the ceramic material is 350 m²/g. Mercury porosimetry indicated that the ceramic material comprises a void volume of 3091 mm³/g. Mercury porosimetry indicated that the ceramic material is 92% porous relative to the bulk oxide material.

### Example 41

A clean 4006 aluminum foil substrate was coated with a porous ceramic surface based on a mixture of magnesium and aluminum oxides. Nitrogen BET surface area measurements indicate that the surface area is about 170 square meters per square meter of projected substrate surface area and that the mass specific surface area of the ceramic material about 700 m²/g. Mercury porosimetry indicated that the ceramic material comprises a void volume of 3067 mm³/g. Mercury porosimetry indicated that the ceramic material is 92% porous relative to the bulk oxide material.

### Example 42

A clean 4006 aluminum foil substrate was coated with a porous ceramic surface based on a mixture of magnesium and aluminum oxides. Nitrogen BET surface area measurements indicate that the surface area is about 85 square meters per square meter of projected substrate surface area and that the mass specific surface area of the ceramic material about 370 m²/g. Mercury porosimetry indicated that the ceramic material comprises a void volume of about 4900 mm³/g. Mercury porosimetry indicated that the ceramic material is 95% porous relative to the bulk oxide material.

### Example 43

A clean 3003 aluminum plate was coated with a porous ceramic surface based on a mixture of zinc and aluminum hydroxides. The plate was then placed in a sealed vial containing 1 cm of isopropanol. After 30 seconds the isopropanol had climbed about 0.5 cm above the liquid line. After 5 minutes the isopropanol had climbed 1 cm above the liquid line. The plate was then removed and allowed to dry. The surface was then functionalized using a dilute solution of hexadecylphosphonic acid in isopropanol using a similar procedure to that in Example 16. The plate was then placed in a sealed vial containing 1 cm of isopropanol. After 30 seconds the isopropanol had climbed about 0.6 cm above the liquid line. After 5 minutes the isopropanol had climbed 1.4 cm above the liquid line. A schematic representing this method is shown in FIGS. 1A-1C.

### Example 44

A clean 3003 aluminum plate was coated with a porous ceramic surface based on a mixture of magnesium and aluminum hydroxides. The plate was then placed in a sealed vial containing 1 cm of isopropanol. After 30 seconds the isopropanol had climbed about 1.4 cm above the liquid line. After 5 minutes the isopropanol had climbed 3.5 cm above the liquid line. The plate was then removed and allowed to dry. The surface was then functionalized using a dilute solution of hexadecylphosphonic acid in isopropanol using a similar procedure to that in Example 16. The plate was then placed in a sealed vial containing 1 cm of isopropanol. After 30 seconds the isopropanol had climbed about 1.5 cm above the liquid line. After 5 minutes the isopropanol had climbed 3.6 cm above the liquid line. A schematic representing this method is shown in FIGS. 1A-1C.

### Example 45

A clean 3003 aluminum plate was coated with a porous ceramic surface based on a mixture of manganese and aluminum hydroxides. The surface was then functionalized using a dilute solution of hexadecylphosphonic acid in isopropanol using a similar procedure to that in Example 16. The plate was then placed in a sealed vial containing 1 cm of isopropanol. After 30 seconds the isopropanol had climbed about 0.6 cm above the liquid line. After 5 minutes the isopropanol had climbed 1.7 cm above the liquid line. A schematic representing this method is shown in FIGS. 1A-1C.

### Example 46

A clean 3003 aluminum plate was coated with a porous ceramic surface based on a mixture of magnesium and aluminum oxides. The coating process was similar to the process used in Example 36 with the only difference being the aluminum alloy. The water contact angle was measured to be less than 5 degrees via the sessile drop method. The plate was then placed into a cup with about 4 centimeter of deionized water. After 30 seconds the capillary rise was determined to be about 0.8 centimeters above the liquid level, and after 5 minutes it had climbed 2 cm. A schematic representing this method is shown in FIGS. 1A-1C.

### Example 47

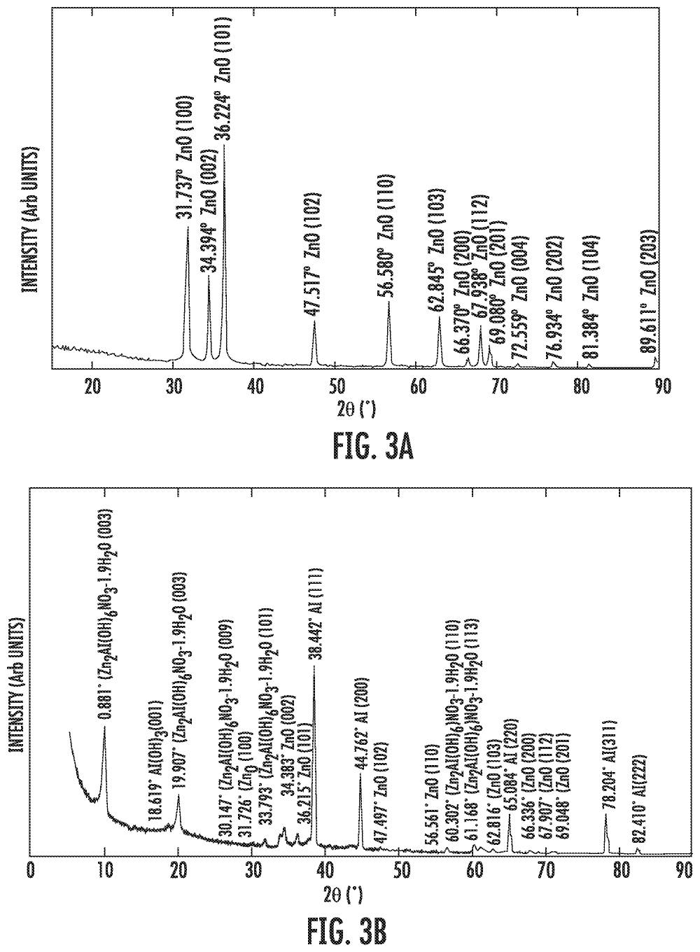

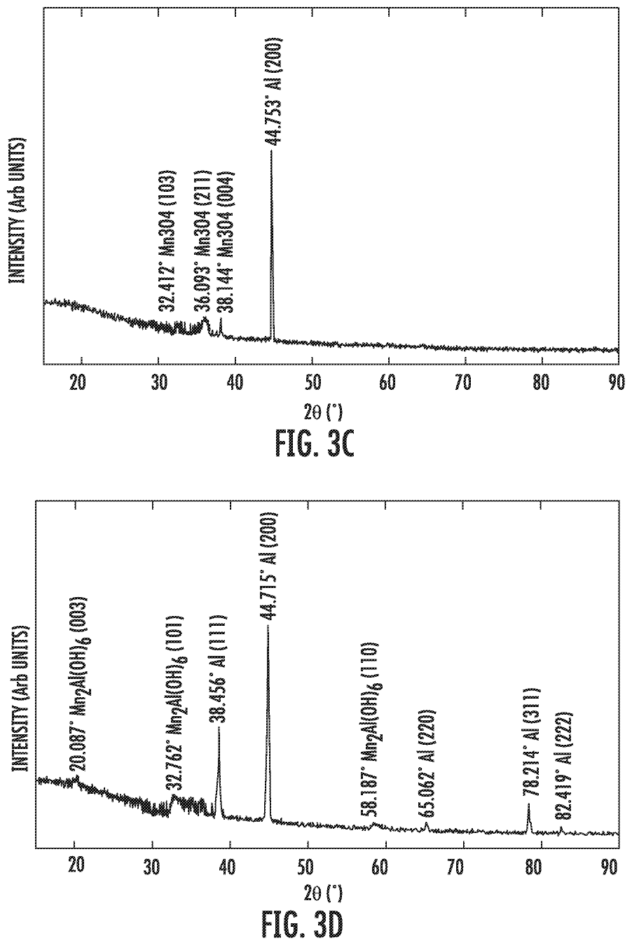

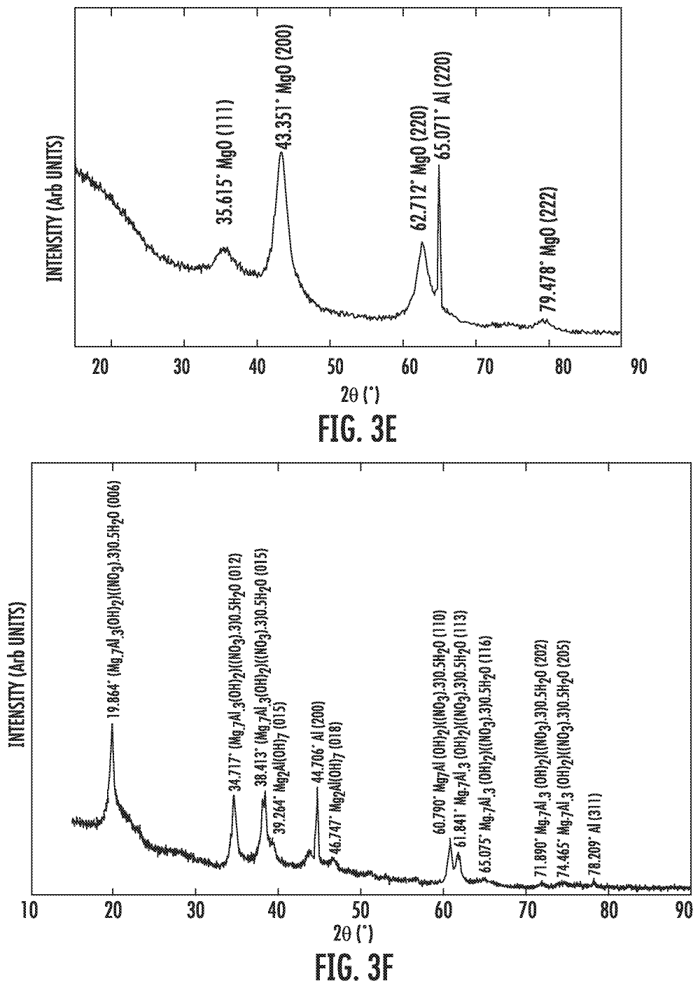

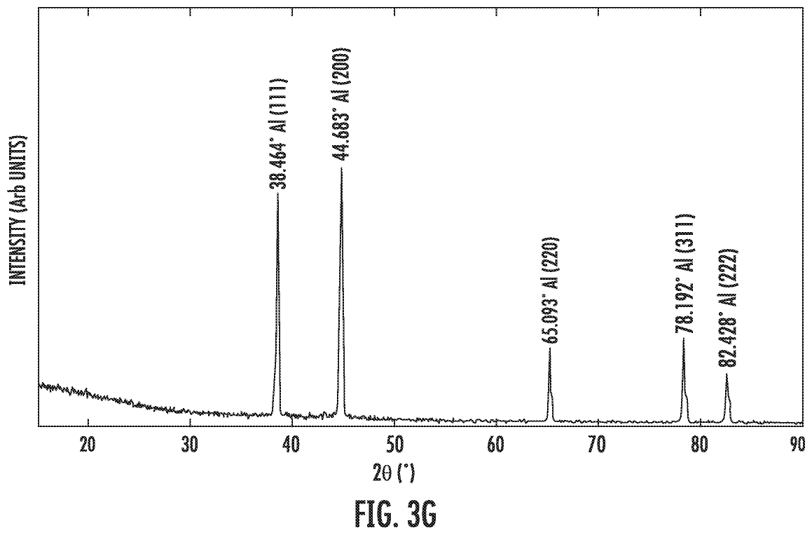

A clean substrate containing 99.999% aluminum was coated with a porous ceramic surface based on zinc and aluminum oxides. The sample was analyzed using Grazing Incidence X-ray Diffraction with Cu K-alpha radiation. The measurement was a 2-theta scan with a scan range of 15 to 90 degrees and a 1 degree incidence angle. The resulting X-ray diffraction peaks verified that the surface material was crystalline and primarily comprised zinc oxide. The resulting spectra is shown in FIG. 3A.

### Example 48

A clean substrate containing 99.999% aluminum was coated with a porous ceramic surface based on zinc and aluminum hydroxides. The sample was analyzed using Grazing Incidence X-ray Diffraction with Cu K-alpha radiation. The measurement was a 2-theta scan with a scan range of 15 to 90 degrees and a 1 degree incidence angle. The resulting X-ray diffraction peaks verified that the surface material was crystalline and primarily comprised a zinc-aluminum double layered hydroxide. The resulting spectra is shown in FIG. 3B.

### Example 49

A clean substrate containing 99.999% aluminum was coated with a porous ceramic surface based on manganese oxides. The sample was analyzed using Grazing Incidence X-ray Diffraction with Cu K-alpha radiation. The measurement was a 2-theta scan with a scan range of 15 to 90 degrees and a 1 degree incidence angle. The resulting X-ray diffraction peaks verified that the surface material was crystalline and primarily comprised a manganese oxides. The resulting spectra is shown in FIG. 3C.

### Example 50

A clean substrate containing 99.999% aluminum was coated with a porous ceramic surface based on manganese and aluminum hydroxides. The sample was analyzed using Grazing Incidence X-ray Diffraction with Cu K-alpha radiation. The measurement was a 2-theta scan with a scan range of 15 to 90 degrees and a 1 degree incidence angle. The resulting X-ray diffraction peaks verified that the surface material was crystalline and primarily comprised a mixed manganese-aluminum hydroxide. The resulting spectra is shown in FIG. 3D.

### Example 51

A clean substrate containing 99.999% aluminum was coated with a porous ceramic surface based on magnesium oxide. The sample was analyzed using Grazing Incidence X-ray Diffraction with Cu K-alpha radiation. The measurement was a 2-theta scan with a scan range of 15 to 90 degrees and a 1 degree incidence angle. The resulting X-ray diffraction peaks verified that the surface material was crystalline and primarily comprised magnesium oxide. The resulting spectra is shown in FIG. 3E.

### Example 52

A clean substrate containing 99.999% aluminum was coated with a porous ceramic surface based on magnesium and aluminum hydroxides. The sample was analyzed using Grazing Incidence X-ray Diffraction with Cu K-alpha radiation. The measurement was a 2-theta scan with a scan range of 15 to 90 degrees and a 1 degree incidence angle. The resulting X-ray diffraction peaks verified that the surface material was composed of a magnesium-aluminum double layered hydroxide. The resulting spectra is shown in FIG. 3F.

### Example 53

A clean substrate containing 99.999% aluminum not coated with any additional material. The sample was analyzed using Grazing Incidence X-ray Diffraction with Cu K-alpha radiation. The measurement was a 2-theta scan with a scan range of 15 to 90 degrees and a 1 degree incidence angle. The resulting X-ray diffraction peaks verified that the surface was composed of pure aluminum. The resulting spectra is shown in FIG. 3G.

### Example 54

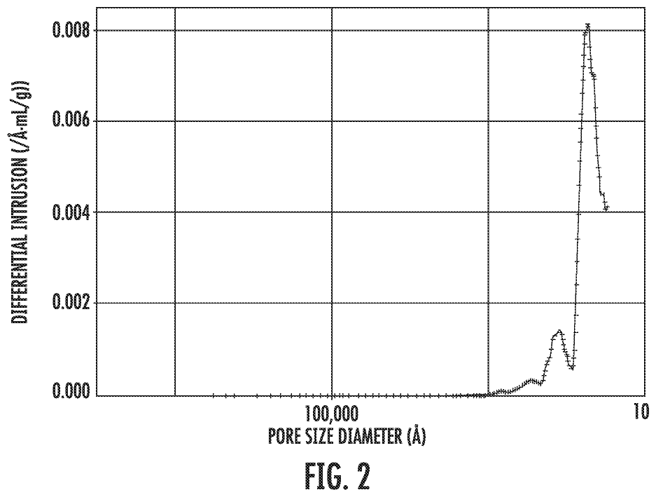

A clean 4006 aluminum foil substrate was coated with a porous ceramic surface based on a mixture of magnesium and aluminum oxides. Nitrogen BET surface area measurements indicate that the surface area is 180 square meters per square meter of projected substrate surface area and that the mass specific surface area of the ceramic material was 300 m²/g. Mercury porosimetry indicates that there is a bimodal pore size distribution with pores sizes concentrated at about 12.7 nm and at about 5 nm. The pore size distribution is shown in FIG. 2. Mercury porosimetry indicated that the ceramic material comprises a void volume of 1450 mm³/g. Mercury porosimetry indicated that the ceramic material is 84% porous relative to the bulk oxide material.

Although the foregoing invention has been described in some detail by way of illustration and examples for purposes of clarity of understanding, it will be apparent to those skilled in the art that certain changes and modifications may be practiced without departing from the spirit and scope of the invention. Therefore, the description should not be construed as limiting the scope of the invention which is delineated in the appended claims.

All publications, patents, and patent applications cited herein are hereby incorporated by reference in their entireties for all purposes and to the same extent as if each individual publication, patent, or patent application were specifically and individually indicated to be so incorporated by reference.

1. A composition comprising a binderless porous ceramic material on a substrate.

2. The composition according to claim 1, wherein the porous ceramic material is primarily crystalline.

3. The composition according to claim 1, wherein the ceramic material comprises a metal oxide, a hydrate of a metal oxide, a metal hydroxide, a layered double hydroxide, and/or a hydrate of a metal hydroxide.

4. (canceled)

5. The composition according to claim 1, wherein the ceramic material comprises a surface area of about 10 m² to 1500 m² per square meter of projected substrate area.

6. (canceled)

7. The composition according to claim 1, wherein the ceramic material comprises a mean pore diameter of about 2 nm to about 20 nm.

8. The composition according to claim 1, wherein the pore size distribution is multimodal.

9. The composition according to claim 1, wherein the ceramic material comprises a thickness up to about 50 micrometers.

10.-11. (canceled)

12. The composition according to claim 1, wherein the ceramic material comprises a porosity greater than about 10%.

13. (canceled)

14. The composition according to claim 1, wherein the ceramic material comprises a void volume of about 100 mm³/g to about 7500 mm³/g as determined by mercury intrusion porosimetry.

15. The composition according to claim 1, wherein the substrate comprises aluminum, an aluminum alloy, a steel alloy, an iron alloy, zinc, a zinc alloy, copper, a copper alloy, nickel, nickel alloys, titanium, titanium alloys, glass, a polymer, a co-polymer, or plastic.

16. A composition according to claim 1, wherein the ceramic material comprises a transition metal, a Group II element, a rare-earth element, aluminum, tin, or lead.

17. (canceled)

18. The composition according to claim 1, wherein the ceramic material comprises: a mixture of zinc and aluminum oxides and/or hydroxides; a mixture of manganese and magnesium oxides and/or hydroxides; manganese oxide and/or hydroxide; aluminum oxide and/or hydroxide; a mixed metal manganese oxide and/or hydroxide; a mixture of magnesium and aluminum oxides and/or hydroxides; magnesium oxide and/or hydroxide; a mixture of magnesium, cerium, and aluminum oxides and/or hydroxides; a mixture of zinc, praseodymium, and aluminum oxides and/or hydroxides; a mixture of cobalt and aluminum oxides and/or hydroxides; a mixture of manganese and aluminum oxides and/or hydroxides; a mixture of cerium and aluminum oxides and/or hydroxides; a mixture of copper and aluminum oxides and/or hydroxides; a mixture of zinc and aluminum oxides and/or hydroxides; a mixture of Zn-aluminates; a mixture comprising one or more phases comprising Zn, Al and oxygen; zinc oxide and/or hydroxide; or a hydrate of any of the above compounds or mixtures

19. The composition according to claim 18, wherein the substrate comprises aluminum, iron, nickel, titanium, or copper.

20. The composition according to claim 1, wherein the ceramic material provides one or more functional characteristic selected from enhanced wettability, hardness, elasticity, mechanical, electrical, piezoelectric, optical, adhesion, or thermal properties, microbial affinity or resistance, alteration of biofilm growth, catalytic activity, permeability, aesthetic appearance, liquid repellency, and corrosion resistance, in comparison to a substrate that does not comprise the ceramic material.

21. (canceled)

22. The composition according to claim 1, wherein the ceramic material comprises an open cell porous structure.

23. The composition according to claim 22, wherein the open cell porous structure is characterized by capillary rise of a solvent comprising a surface tension less than about 25 mN/m of greater than about 5 mm up a vertical surface against a gravitational force of about 1G in an atmosphere saturated with the solvent in 1 hour at a temperature of about 15° C. to about 25° C.

24. The composition according to claim 1, wherein the ceramic material comprises pores that are partially, substantially, or completely filled with a gas, liquid, or solid substance, or combinations thereof.

25. The composition according to claim 24, wherein the ceramic material comprises pores that are less than 50% filled with the liquid and/or pores that comprise liquid that is not stably contained or retained within the pores.

26. The composition according to claim 1, wherein the ceramic material comprises pores that are filled with a mixture of a first material and a second material, wherein the pores are first partially filled with the first material and then partially or completely filled with the second material.

27. The composition according to claim 26, wherein one or more functional characteristic of the ceramic material is altered by inclusion of the first and/or second material.

28.-30. (canceled)

31. The composition according to claim 27, wherein the one or more functional characteristic comprises wettability, hardness, elasticity, mechanical, electrical, piezoelectric, optical, adhesion, or thermal properties, microbial affinity or resistance, alteration of biofilm growth, catalytic activity, permeability, aesthetic appearance, liquid repellency, and/or corrosion resistance.

32. The composition according to claim 24, further comprising a layer of a top surface material over the ceramic material, wherein the top surface material provides a functionality comprising wettability with a liquid or selective separation of compounds in a liquid.

33. The composition according to claim 32, wherein the top surface material interacts with the gas, liquid, or solid substance inside the pores, thereby providing a functionality selected from thermal management, wettability, electrochemical reactivity modulation, or mechanical property modulation.

34.-36. (canceled)

37. The composition according to claim 33, wherein the top surface material comprises an ammonium group, an alkyl group, a perfluoroalkyl group, a fluoroalkyl group, a phenyl group, a polymer, and/or a ceramic.

38. The composition according to claim 37, wherein the top surface material comprises quaternary ammonium groups that impart anti-microbial activity, alkyl groups that impart water repellency, alkyl groups that impart hydrocarbon affinity, perfluoroalkyl groups that impart water repellency, perfluoroalkyl groups that impart oil repellency, a polymer that imparts an improved mechanical property, and/or a ceramics that imparts an improved aesthetic performance, optoelectronic performance, or anti-corrosive performance.

39. The composition according to claim 24, wherein the gas, liquid, or solid substance inside the pores interacts with the ceramic material, thereby providing one more functionality selected from wettability, hardness, elasticity, mechanical, electrical, piezoelectric, optical, adhesion, or thermal properties, microbial affinity or resistance, alteration of biofilm growth, catalytic activity, permeability, aesthetic appearance, liquid repellency, and corrosion resistance.

40. The composition according to claim 24, wherein moisture in the environment interacts with the gas, solid, or liquid substance inside the pores, thereby providing one or more functionality selected from modulated evaporation rate, condensation, or water crystallization, corrosion protection of the substrate, and/or wettability enhancement.

41. The composition according to claim 24, wherein the ceramic material is a substantially filled or completely filled porous structure, wherein the pores are filled with another ceramic material or a polymer.

42. The composition according to claim 24, wherein the ceramic material is a partially filled porous structure, wherein the pores are partially filled with a ceramic or with a molecule with a head group and a tail group, wherein the head group comprises a silane group, a sulfonate group, a sulfonic acid group, a boronate group, a boronic acid group, a phosphonate group, a phosphonic acid group, a carboxylate group, a carboxylic acid group, a vinyl group, a hydroxide group, an alcohol group, a thiolate group, a thiol group, and/or an quaternary ammonium group, and wherein the tail group comprises a hydrocarbon group, a fluorocarbon group, a vinyl group, a phenyl group, an epoxide group, an acrylic group, an acrylate group, a hydroxyl group, a carboxylic acid group, a thiol group, and/or a quaternary ammonium group.

43. The composition according to claim 1, wherein the ceramic material provides an asymmetric pore structure with respect to ceramic thickness from the substrate.

44. (canceled)

45. The composition according to claim 1, wherein the substrate comprises a metal, and wherein the primary metal in the ceramic material is different than the primary metal in the substrate.

46. A method for making a composition according to claim 1, comprising:
(a) depositing the binderless ceramic porous material onto the substrate, said depositing comprising dipping, spraying, roll coating, or otherwise contacting the substrate with an aqueous solution that comprises one or more metal salt(s) and a chelating or complex forming agent, and controlling the pH and temperature to modulate the reaction rate to produce a ceramic material comprising a desired crystal structure, morphology, and/or surface porosity; and
(b) removing the substrate from the solution and heating and/or calcining the substrate to drive off moisture.

47. The method according to claim 46, further comprising:
(c) dipping the substrate into a dilute solution of a functional molecule with a solvent capable of chemically binding to the ceramic surface such that the pores are functionalized but remain open.

48.-49. (canceled)

50. The composition according to claim 1, adapted for use as a heat transfer surface, a fluid barrier, a filter, a fabric or textile, a corrosion barrier, a light absorbing surface, a catalyst or a separation medium.
